(19) United States
(12) Patent Application Publication
(10) Pub. No.: US 2019/0039796 A1
(43) Pub. Date: Feb. 7, 2019

(54) DURABLE LUBRICIOUS SURFACES

(71) Applicant: LiquiGlide Inc., Cambridge, MA (US)

(72) Inventors: Taylor A. FARNHAM, 93023, CA (US); Tao CONG, Arlington, MA (US); Ari UMANS, Somerville, MA (US); Kripa VARANASI, Lexington, MA (US); Jonathan David SMITH, Arlington, MA (US); Dillp THEKKOODAN, Cambridge, MA (US)

(21) Appl. No.: 16/153,056

(22) Filed: Oct. 5, 2018

Related U.S. Application Data
(63) Continuation of application No. PCT/US2018/027340, filed on Apr. 12, 2018.
(60) Provisional application No. 62/485,183, filed on Apr. 13, 2017.

(51) Int. Cl. B65D 65/42; B32B 1/02; B32B 3/30; B32B 7/12

(52) U.S. Cl. CPC B65D 65/42; B32B 1/02; B32B 2439/00; B32B 7/12; B32B 3/30

(57) ABSTRACT

Embodiments, described herein relate generally to devices, systems, and methods for producing lubricious surfaces with enhanced durability and which increase the ease of communication of viscous liquids across the same. The system can include a liquid-encapsulated surface including a substrate, a member coupled to the substrate, and an encapsulating liquid disposed on a surface of the member. In some embodiments, the surface of the member can have a chemistry such that the encapsulating liquid preferentially wets the surface and maintains lubricity in the presence of a contacting phase. In some embodiments, the encapsulating liquid can be substantially immiscible with the contacting phase, and/or can have a thickness of less than about 200 microns and/or can have a receding contact angle of less than 20 degrees in the presence of the contacting phase. In some embodiments, a liquid delivery mechanism can be configured to transfer the encapsulating liquid to the member.

### CROSS-REFERENCE TO RELATED APPLICATIONS

This application claims priority to and the benefit of U.S. Provisional Patent Application Ser. No. 62/485,183, filed Apr. 13, 2017 and titled “Durable Lubricious Surfaces,” the disclosure of which is hereby incorporated by references in its entirety.

### BACKGROUND

Embodiments described herein relate generally to devices, systems and methods for producing lubricious surfaces with enhanced durability.

Viscous liquids are ubiquitous in manufacturing. Often, viscous liquids and semi solids are manufactured or stored in metal tanks and transported through pipes. Other times viscous liquids and semi solids come into contact with non-enclosed surfaces. The interface between viscous liquids and the contact surface of the tank, pipe or other surface is a no-slip boundary, meaning that viscous liquids stick to these surfaces, resulting in costly inefficiencies, including loss of product and costs associated with cleaning tanks and pipes coated with viscous liquids, including but not limited to labor costs and waste-water disposal costs. Under some circumstances, cleaning tanks can result in safety risks for people who have to clean tanks in confined spaces. Engineered surfaces are surfaces dimensioned such that specific characteristics, properties, and interactions occur that otherwise would not likely occur. The advent of micro/nano-engineered surfaces in the last decade has opened up new techniques for enhancing a wide variety of physical phenomena in thermofluids sciences. For example, the use of micro/nano surface textures has provided non-wetting surfaces capable of achieving less viscous drag, reduced adhesion to ice and other materials, self-cleaning, and water repellency. These improvements result generally from diminished contact (i.e., less wetting) between the solid surfaces and adjacent liquids.

One type of non-wetting surface of interest is a super hydrophobic surface. In general, a super hydrophobic surface includes micro/nano-scale roughness on an intrinsically hydrophobic surface, such as a hydrophobic coating. Super hydrophobic surfaces resist contact with water by virtue of an air-water interface within the micro/nano surface textures that allow for a higher proportion of the surface area beneath the droplet to be air.

One of the drawbacks of existing non-wetting surfaces (e.g., super hydrophobic, super oleophobic, and super metallophobic surfaces) is that they are susceptible to impalement, which destroys the non-wetting capabilities of the surface. Impalement occurs when a liquid in contact with the surface displaces the air pockets or air layer that is trapped within the surface textures; i) the air pockets can be collapsed by external wetting pressures (such as when the superhydrophobic surface is exposed to large hydrostatic pressures or impacting liquids), ii) the air pockets can diffuse away into the surrounding liquid, iii) the surface can lose robustness upon damage to the texture, iv) the air pockets may be displaced by low surface tension liquids unless special texture design is implemented, and v) condensation or frost nuclei, which can form at the nanoscale throughout the texture, can completely transform the wetting properties and render the textured surface highly wetting. Previous efforts to prevent impalement have focused on reducing surface texture dimensions from micro-scale to nano-scale, which has had some success in preventing impalement in static or non-industrial environments, though to a lesser extent in dynamic, industrial, and other environments for which surface interactions can be forceful.

Another drawback with existing non-wetting surfaces is that they are susceptible to ice formation and adhesion. For example, when frost forms on existing super hydrophobic surfaces, the surfaces become hydrophilic. Under freezing conditions, water droplets can stick to the surface, and ice may accumulate. Removal of the ice can be difficult because the ice may interlock with the textures of the surface. Similarly, when these surfaces are exposed to solutions saturated with salts, for example as in desalination or oil and gas applications, scale builds on the surfaces, which results in loss of functionality. Similar limitations of existing non-wetting surfaces include problems with hydrate formation, and formation of other organic or inorganic deposits on the surfaces.

Thus, there is a need for non-wetting surfaces that are more robust. In particular, there is a need for non-wetting surfaces that are more durable and can maintain slippery properties even after repeated use and when used in more severe manufacturing conditions and other environments.

### SUMMARY

Embodiments, described herein relate generally to devices, systems, and methods for producing lubricious surfaces with enhanced durability and which increase the ease of communication of viscous liquids across the same. In some embodiments, the system can include a liquid-encapsulated surface including a substrate, a member coupled to the substrate, and an encapsulating liquid disposed on a surface of the member. In some embodiments, the surface of the member can have a chemistry such that the encapsulating liquid preferentially wets the surface and maintains lubricity in the presence of a contacting phase. In some embodiments, the encapsulating liquid can be substantially immiscible with the contacting phase. In some embodiments, the encapsulating liquid can have a thickness of less than about 200 microns and/or a receding contact angle of less than 20 degrees in the presence of the contacting phase. In some embodiments, the system can include a liquid delivery mechanism configured to transfer the encapsulating liquid to the member.

In some embodiments, a removable member having a plurality of solid features (e.g., micro-scale and/or nano-scale solid features) and/or a predetermined surface chemistry (also referred to as an “engineered surface chemistry”) can be disposed on a native surface and impregnated and/or encapsulated with a liquid such that a liquid impregnated surface and/or liquid encapsulated surface is created with enhanced durability. In some embodiments, the plurality of solid features are spaced sufficiently close to contain an impregnating liquid regardless of orientation of the removable texturing member. In some embodiments, the space between the plurality of solid features, bounded by the surface of the removable texturing member, comprise the interstitial regions wherein impregnating liquid is contained. In some embodiments, the removable member can have little or no texture, but carefully chosen surface chemistry (i.e., engineered) such that when combined with an appropriate lubricious liquid the liquid encapsulates the surface of the member. The combination of the surface chemistry of the removable member and the liquid (also referred to as an “encapsulating liquid”) results in a stable lubricious film of liquid disposed on the surface of the removable member via strong Van der Waals forces, which can enable a lubricious surface with enhanced durability. In some embodiments, the native surface of the tank, pipeline or other surface feature defines a first surface, having a first roll off angle. In some embodiments, an impregnating or encapsulating liquid is disposed within the interstitial regions through capillary forces, or bonded to the surface as a stable thin film via Van der Waals forces. In some embodiments, the impregnating or encapsulating liquid disposed on the removable member defines a second surface having a second roll off angle less than the first roll off angle. In some embodiments, excess liquid (i.e., any liquid on the surface in excess of what is stabilized by Van der Waals forces or capillary forces), can be disposed on the surface to create a layer of liquid that is mobile above the removable member. In some embodiments, liquid will be mobile over and between the interstitial regions of the removable member. The liquid mobility allows liquid to move tangential to (along) the surface, but capillary forces or Van der Waals forces prevent liquid from moving normal to (away from) the surface. In some embodiments, the apparatus can include a liquid delivery mechanism comprising a reservoir containing a replenishing supply of impregnating liquid, configured to transfer impregnating or encapsulating liquid on demand to the interstitial regions at a controlled rate.

### BRIEF DESCRIPTION OF THE DRAWINGS

FIG. 1 is a schematic illustration of an apparatus that includes a liquid-impregnated surface and a liquid delivery mechanism, according to an embodiment.

FIG. 2A shows a liquid-impregnated surface disposed to a removably-coupled texturing member configured for a replenishing supply of impregnating liquid to be disposed to the interstitial regions in a controlled manner such that the contact surface area ϕ₁ (phi; the fraction of solid/liquid interface where a drop is in contact with the surface) remains minimized over time, according to an embodiment. FIG. 2B shows a liquid-impregnated surface disposed to a removably-coupled textured member not configured for a replenishing supply of impregnating liquid to be disposed to the interstitial regions, such that ϕ₂>ϕ₁, resulting in a shorter slip length and a larger roll off angle, according to an embodiment.

FIG. 3A shows a high-phi configuration of a liquid-impregnated surface showing spaces between the textures partially filled and the exposed peaks of the textured member, according to an embodiment. FIG. 3B shows a low-phi configuration of a liquid-impregnated surface, which can be further enhanced by having an additional mobile phase of impregnation liquid or a different liquid that does not displace the impregnation liquid layer disposed to the interface between the liquid-impregnated surface and the contact liquid, according to an embodiment.

FIG. 4A-4C are schematic illustrations of a portion of a container having a removably-coupled texturing member and a liquid delivery mechanism, according to an embodiment.

FIG. 5 shows a flow chart illustrating a method for forming a liquid-impregnated surface with enhanced durability using a texturing member, according to an embodiment.

### DETAILED DESCRIPTION

Some known engineered surfaces with designed chemistry and roughness, possess substantial non-wetting (hydrophobic) properties, which can be extremely useful in a wide variety of commercial and technological applications. Some hydrophobic surfaces are inspired by nature, such as for example, the lotus plant which includes air pockets trapped within the micro or nano-textures of the surface, increasing the contact angle of a contact liquid (e.g., water or any other aqueous liquid) disposed on the hydrophobic surface. As long as these air pockets are stable, the surface continues to exhibit hydrophobic behavior. Such known hydrophobic surfaces that include air pockets, however, present certain limitations including, for example: i) the air pockets can be collapsed by external wetting pressures, ii) the air pockets can diffuse away into the surrounding liquid, iii) the surface can lose robustness upon damage to the texture, iv) the air pockets may be displaced by low surface tension liquids unless special texture design is implemented, and v) condensation or frost nuclei, which can form at the nanoscale throughout the texture, can completely transform the wetting properties and render the textured surface highly wetting. These limitations are especially true for engineered surfaces in dynamic, industrial, and severe manufacturing environments.

Non-wetting surfaces can also be formed by disposing a liquid-impregnated or liquid-encapsulated surface on a substrate. Such liquid-impregnated or liquid-encapsulated surfaces can be non-wetting to any liquid, i.e. omniphobic (e.g. super hydrophobic, super oleophobic, or super metallophobic), can be configured to resist ice and frost formation, and can be highly durable. Liquid-impregnated surfaces can be disposed on any substrate, for example, on the inner surface of pipes, containers, or vessels, and can be configured to present a non-wetting surface to a wide variety of products, for example, food products, pharmaceuticals, over-the-counter drugs, nutraceuticals, health and beauty products, industrial greases, inks, bitumen, cement, adhesives, hazardous waste, consumer products, or any other product, such that the product can be evacuated, detached, or otherwise displaced with substantial ease on the liquid-impregnated surface.

Liquid-impregnated surfaces described herein, include impregnating liquids that are impregnated into a rough surface that includes a matrix of solid features defining interstitial regions, such that the interstitial regions include pockets of impregnating liquid. The impregnating liquid is configured to wet the solid surface preferentially and adhere to the micro-nano textured member with strong capillary forces, such that the contact liquid has an extremely high advancing contact angle and an extremely low roll off angle (e.g., a roll off angle of about 1 degree and a contact angle of greater than about 100 degrees). This enables the contact liquid to displace with substantial ease on the liquid-impregnated surface. Therefore, the liquid-impregnated surfaces described herein, provide certain significant advantages over conventional super hydrophobic surfaces including: i) the liquid-impregnated surfaces creates a low hysteresis for the product, ii) such liquid-impregnated surfaces can include self-cleaning properties, iii) can withstand high drop impact pressure (i.e., are wear resistant), iv) can self heal by capillary wicking upon damage, v) can repel a variety of contact liquids, such as semisolids, slurries, mixtures and/or non-Newtonian fluids, for example, water, edible liquids or formulations (e.g., ketchup, catsup, mustard, mayonnaise, syrup, honey, jelly, etc.), environmental fluids (e.g., sewage, rain water), bodily fluids (e.g., urine, blood, stool), or any other fluid (e.g. hair gel, toothpaste), vi) can reduce ice formation, vii) enhance condensation, viii) allow mold release, ix) prevent corrosion, x) reduce ice or gas hydrate adhesion, xi) prevent scaling from salt or mineral deposits, xii) reduce biofouling, and xiii) enhance condensation. Examples of liquid-impregnated surfaces, methods of making liquid-impregnated surfaces and applications thereof, are described in U.S. Pat. No. 8,574,704, entitled “Liquid-Impregnated Surfaces, Methods of Making, and Devices Incorporating the Same,” filed Aug. 16, 2012, the entire contents of which are hereby incorporated by reference herein. Examples of materials used for forming the solid features on the surface, impregnating liquids, and applications involving edible contact liquids, are described in U.S. Pat. No. 8,535,779, entitled “Self-Lubricating Surfaces for Food Packaging and Food Processing Equipment,” issued Sep. 17, 2013, the entire contents of which are hereby incorporated by reference herein. Examples of non-toxic liquid-impregnated surfaces are described in U.S. Provisional Application No. 61/878,481, (the '481 application) entitled “Non-toxic Liquid-Impregnated Surfaces”, filed Sep. 16, 2013, the entire contents of which are hereby incorporated by reference herein. Examples of lubricious liquid surfaces and methods of forming liquid surface films on the interior surfaces of containers, are described in U.S. Patent Publication No. 2015/0079315 entitled “Articles and Methods for Forming Liquid Films on Surfaces, in Devices Incorporating the Same,” filed Sep. 17, 2014, the entire contents of which are hereby incorporated by reference herein.

In some cases, the impregnating liquid included in the liquid-impregnated surface can get displaced from within the interstitial regions defined by the solid features included in the liquid-impregnated surface. For example, the shearing force exerted on the liquid-impregnated surface from a bulk fluid (e.g., a non-Newtonian fluid) flowing over the liquid-impregnated surface can shear the impregnating liquid from the liquid-impregnated surface. This can lead to gradual loss of the impregnating liquid and can lead to a decrease in the non-wetting performance of the liquid-impregnated surface.

Embodiments of a liquid-impregnated surface utilizing a texturing member, described herein, include articles, systems and methods configured to provide a replenishing supply of the impregnating liquid to the liquid-impregnated surface. This can ensure that any volume of the impregnating liquid lost from the liquid-impregnated surface is replaced with fresh impregnating liquid such that the non-wetting properties of the liquid-impregnated surface are maintained. Thus, the liquid-impregnated surfaces described herein can have enhanced durability and long lifetime. The liquid-impregnated or liquid-encapsulated surfaces described herein can be used in systems where a continuous flow or repeated flow of a liquid is desired over extended periods of times, for example, process tubes, pipes, conduits, vessels, multi-use containers, or any other article or container.

In some embodiments, a system including a lubricious surface can be used to increase the ease of communication of viscous liquids across the same. In some embodiments, the system can include a liquid-encapsulated surface including a substrate, a member coupled to the substrate, and an encapsulating liquid disposed on a surface of the member. In some embodiments, the surface of the member can have a chemistry such that the encapsulating liquid preferentially wets the surface and maintains lubricity in the presence of a contacting phase. In some embodiments, the encapsulating liquid can be substantially immiscible with the contacting phase. In some embodiments, the encapsulating liquid can have a thickness of less than about 200 microns and/or a receding contact angle of less than 20 degrees in the presence of the contacting phase. In some embodiments, the system can include a liquid delivery mechanism configured to transfer the encapsulating liquid to the member. In some embodiments, the member can be configured to be removably coupled to the substrate. In some embodiments, the member can include an adhesive backing configured to be removably coupled to the substrate. In some embodiments, the liquid delivery mechanism can include a porous tubular member configured to transfer a controlled volume of the encapsulating liquid to the member. In some embodiments, the liquid delivery mechanism includes a reservoir configured to contain a supply of encapsulating liquid. In some embodiments, the reservoir can be operably coupled and/or fluidically coupled to the member such that a supply of encapsulating liquid can flow to the member (e.g., onto a surface of the member). In some embodiments, the liquid delivery mechanism can include a pumping mechanism configured to transfer encapsulating liquid from the reservoir to the member. In some embodiments, the surface of the member can have little or no texture. In other words, in some embodiments, the surface of the member can be substantially smooth.

In some embodiments, the system can include a liquid-impregnated surface that includes a substrate and a texturing member coupled to the substrate. In some embodiments, the texturing member can include a plurality of solid features defining interstitial regions between the plurality of solid features. In some embodiments, an impregnating liquid can be disposed in the interstitial regions. In some embodiments, the interstitial regions can be dimensioned and configured to remain impregnated by the impregnating liquid through capillarity. In some embodiments, a liquid delivery mechanism can be configured to transfer the impregnating liquid to the interstitial regions. In some embodiments, the texturing member can be configured to be removably coupled to the substrate. In some embodiments, the texturing member can include an adhesive backing configured to be removably coupled to the substrate. In some embodiments, the liquid delivery mechanism can include a porous tubular member configured to transfer a controlled volume of the impregnating liquid to the interstitial regions. In some embodiments, the liquid delivery mechanism can include a reservoir configured to contain a supply of impregnating liquid, the reservoir fluidically coupled to the interstitial regions such that a supply of impregnating liquid can flow into the interstitial regions by capillary action. In some embodiments, the reservoir containing the supply of impregnating liquid can have a higher pressure than the interstitial regions such that the supply of impregnating liquid is forced into the interstitial regions by the pressure differential. In some embodiments, the liquid delivery mechanism can include a pumping mechanism configured to transfer impregnating liquid from the reservoir to the interstitial regions.

In some embodiments, the system can include a container having an interior surface defining an interior region configured to contain the liquid. In some embodiments, the texturing member can be disposed on the interior surface, the texturing member having a plurality of solid features defining interstitial regions between the plurality of solid features. In some embodiments, the impregnating liquid can be disposed in the interstitial regions, the interstitial regions dimensioned and configured such that capillary forces retain the impregnating liquid in the interstitial regions. In some embodiments, the system can include a liquid delivery mechanism configured to transfer the impregnating liquid to the interstitial regions. In some embodiments, the texturing member can be a liner configured to be disposed in the container. In some embodiments, the interior surface of the container is a first surface having a first roll off angle. In some embodiments, a second surface, formed at least in part by the texturing member and the impregnating liquid, has a second roll off angle less than the first roll off angle. In some embodiments, the second surface has an emerged area fraction ϕ in a range of 0<ϕ<0.25. In some embodiments, the emerged area fraction can be 0.01<ϕ<0.25. In some embodiments, the second surface can have a spreading coefficient Sₒₑ₍ᵥ₎<0. In some embodiments, the texturing member has a Wenzel roughness greater than about 1.01.

In some embodiments, the system can include a container having an interior surface defining an interior region configured to contain the contact liquid, a texturing member disposed on the interior surface, and an impregnating liquid disposed on the texturing member. In some embodiments, the system can include a liquid delivery mechanism configured to transfer the impregnating liquid to the texturing member. In some embodiments, the liquid delivery mechanism can include a porous tubular member configured to transfer a volume of the impregnating liquid to the texturing member. In some embodiments, the liquid delivery mechanism can include a support member coupled to the interior surface of the container. In some embodiments, the liquid delivery mechanism can define a channel configured to receive the porous tubular member. In some embodiments, the support member can be disposed about the circumference of the container. In some embodiments, the contact liquid can include but is not limited to at least one of a food, cosmetic, cement, asphalt, tar, ice cream, egg yolk, water, alcohol, mercury, gallium, refrigerant, toothpaste, paint, peanut butter, jelly, jam, mayonnaise, ketchup, mustard, condiment, laundry detergent, consumer product, gasoline, petroleum product, oil, biological fluid, blood, and plasma.

In some embodiments, a texturing member is configured to be removably coupled to a first surface, thereby creating a second surface. The texturing member includes a plurality of solid features, such that interstitial regions are defined between the plurality of solid features. An impregnating liquid is disposed in the interstitial regions and the interstitial regions are dimensioned and configured such that the impregnating liquid is retained in the interstitial regions through capillarity. The impregnating liquid disposed in the interstitial regions defines a third surface that has a roll off angle less than the roll off angle of the first surface. In some embodiments, the apparatus can include a liquid delivery mechanism configured to transfer impregnating liquid to the interstitial regions.

In some embodiments, the first surface can be considered a native surface. In some embodiments, the texturing member comprises an adhesive surface configured to be removable coupled to the native surface. In other words, the texturing member can be affixed to the native surface for a period of time when it is desirable to modify the lubricity of the native surface, but can then be removed at a later time to return the native surface to its original condition and original degree of lubricity.

In some embodiments, the texturing member includes a plurality of solid features configured and dimensioned such that the spaces between solid features define the interstitial regions. The impregnating liquid is disposed in the interstitial spaces and is retained in the interstitial regions through capillarity, thereby forming the liquid impregnated surface. In some embodiments, the impregnating liquid and portions of the texturing member collectively define the liquid impregnated surface. In some embodiments, the liquid impregnated surface includes a mobile excess layer of impregnating liquid. In some embodiments, the liquid-impregnated surface is fluidically coupled to a reservoir such that a replenishing supply of impregnating liquid can be communicated to the interstitial regions.

In some embodiments, a method of forming a liquid-impregnated surface includes disposing a texturing member on a substrate (also referred to as a native surface). The texturing member includes a plurality of solid features configured and dimensioned such that the space between solid features defines interstitial regions. In some embodiments, the texturing member is fluidically coupled to a separate and distinct reservoir, the reservoir containing a replenishing supply of impregnation liquid. In some embodiments, the interstitial regions are configured and dimensioned such that the replenishing supply of impregnation liquid is communicated to the interstitial regions of the liquid-impregnated surface through capillary action. In some embodiments, the replenishing supply of impregnation liquid is communicated to the interstitial regions through hydraulic pressure exerted by a pumping mechanism. In some embodiments, an impregnating liquid is applied to the texturing member disposed to a first surface with a first roll off angle such that the impregnating liquid fills the interstitial regions between the plurality of solid features and forms a second surface having a second roll off angle less than the first roll off angle. The method further includes reapplying the impregnating liquid to maintain the second roll off angle of the second surface less than the first roll off angle. In some embodiments, the impregnating liquid can be applied from a multi-phase liquid in contact with the impregnating liquid disposed in the interstitial regions. In some embodiments, the impregnating liquid is reapplied through capillary action from a replenishing supply of impregnation liquid mixed with the contact liquid. In some embodiments, the liquid delivery mechanism is in fluid communication with the interstitial regions by at least one of the following: capillary action, pressure differential, temperature differential, concentration and/or surface tension gradients.

As used herein, the term “about” and “approximately” generally mean plus or minus 10% of the value stated, for example about 250 μm would include 225 μm to 275 μm, about 1,000 μm would include 900 μm to 1,100 μm.

As used herein, the term “contact liquid”, “bulk material, and “product” are used interchangeably to refer to a solid or liquid that flows, for example a non-Newtonian fluid, a Bingham fluid, a high viscosity fluid, or a thixotropic fluid and is contact with a liquid-impregnated surface, unless otherwise stated.

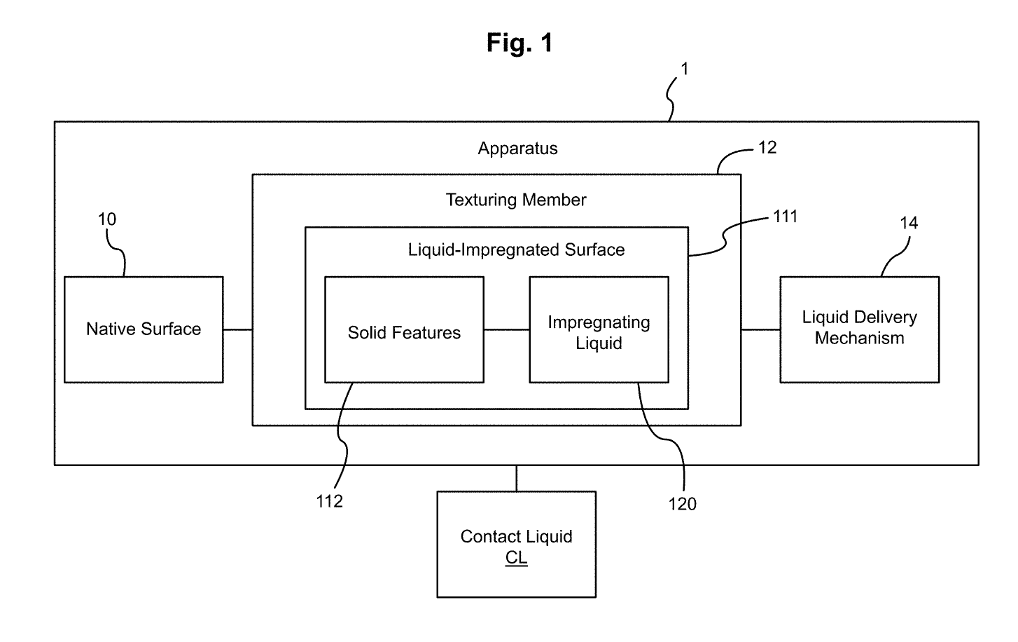

FIG. 1 illustrates a schematic block diagram of an apparatus 1 that includes a native surface 10, texturing member 12, and a liquid delivery mechanism 14. The texturing member 12 includes a plurality of solid features 112 and an impregnating liquid 120 that define a liquid impregnated surface 111. The liquid-impregnated surface 111 can be in contact with a contact liquid CL, such that the contact liquid CL can easily move over the liquid-impregnated surface 111. In other words the liquid-impregnated surface 111 modifies surface properties of the native surface 10 such that the contact liquid CL can more easily flow over the liquid impregnated surface 11 when compared to the native surface 10. The liquid delivery mechanism 14 is configured to transfer the impregnating liquid to the liquid-impregnated surface 111, as described herein.

The native surface 10 can be any surface that is configured to contact a contact liquid. For example, in some embodiments, the native surface 10 can be an inner surface of a container and can have a first roll off angle, for example, a roll off angle of a contact liquid CL (for example, a consumer product, laundry detergent, cough syrup, an edible contact liquid, an industrial liquid, or any other contact liquid described herein). The native surface 10 can be a flat surface, for example an inner surface of a prismatic container, silicon wafer, glass wafer, a table top, a wall, a wind shield, a ski goggle screen, or a contoured surface, for example, a container (e.g. a beverage container), a propeller, a pipe, a tube, an inner surface, of a circular, oblong, rectangular, elliptical, oval or otherwise contoured container.

In some embodiments, the native surface 10 can be an inner surface of a container. The container can include any suitable container such as, for example, tubes, bottles, vials, flasks, molds, jars, tubs, cups, caps, glasses, pitchers, barrels, bins, totes, tanks, kegs, tubs, totes, vessels, syringes, tins, pouches, lined boxes, hoses, cylinders, and cans. In such embodiments, the container can be constructed in almost any desirable shape. In some embodiments, the container can be constructed of rigid or flexible materials. Foil-lined or polymer-lined cardboard or paper boxes can also be used to form the container. In some embodiments, the native surface 10 can include a surface of hoses, piping, conduit, nozzles, syringe needles, dispensing tips, lids, pumps, and other surfaces for containing, transporting, or dispensing the contact liquid CL. In some embodiments, the native surface 10 can be formed from any suitable material including, for example plastic, glass, metal, alloys, ceramics, coated fibers, any other material, or combinations thereof. Suitable surfaces can include, for example, polystyrene, nylon, polypropylene, wax, fluorinated wax, natural waxes, siliconyl waxes, polyethylene terephthalate, polypropylene, poly propylene carbonate, poly imide, polyethylene, polyurethane, graphene, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), perfluoropolyether(PFPE), polychlorotetrafluoroethylene (PCTFE), polyvinyl alcohol (PVA), polyvinyl acetate (PVAc), polyethyleneglycol (PEG), Polyvinylpyrrolidone (PVP), Polylactic acid (PLA), Acrylonitrile butadiene styrene (ABS), Tecnoflon cellulose acetate, poly(acrylic acid), poly(propylene oxide), Dsorbitol, erythritol, xylitol, lactitol, maltitol, mannitol, and polycarbonate.

In some embodiments, the texturing member 12 is disposed on the native surface 10. In some embodiments, the texturing member 12 is coupled to the native surface 10 with an adhesive. In some embodiments, the texturing member 12 has an adhesive backing. In some embodiments, the texturing member 12 is removably coupled to the native surface 10. As described herein, the texturing member 12 includes a plurality of solid features 112 that define interstitial regions between the plurality of solid features 112. In some embodiments, the solid features 112 can be posts, spheres, micro/nano needles, nanograss, pores, grooves, cavities, interconnected pores, inter connected cavities, a mesh, any other random or nonrandom geometry that provides a micro and/or nano surface roughness. In some embodiments, the height of the solid features 112 can be about 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, up to about 1 mm, inclusive of all ranges therebetween, or any other suitable height for receiving the impregnating liquid 120. In some embodiments, the height of the solids features 112 can be less than about 1 μm. For example, in some embodiments, the solid features 112 can have a height of about 1 nm, 5 nm, 10 nm, 20 nm, 30 nm 40 nm, 50 nm, 100 nm, 200 nm, 300 nm, 400 nm, 500 nm, 600 nm, 700 nm, 800 nm, 900 nm, or about 1,000 nm, inclusive of all ranges therebetween. In some embodiments, the height of solid features 112 can be substantially uniform. In some embodiments, the height of solid features 112 can be less than substantially uniform. In some embodiments, the height of solid features 112 can be substantially non-uniform. In some embodiments, the diameter or width of solid features 112 can be substantially uniform. In some embodiments, the diameter of solid features 112 can be less than substantially uniform. In some embodiments, the diameter of solid features 112 can be substantially non-uniform. In some embodiments, the solid features 112 can have a wenzel roughness “r” greater than about 1.01, 1.05, 1.1, 1.2, 1.3, 1.4, 1.5, 1.6, 1.7, 1.8, 1.9, 2.0, 2.5, 3, 5, or about 10. In some embodiments, the solid features 112 can have an interstitial spacing, for example, in the range of about 1 μm to about 100 μm, or about 1 nm to about 1 μm. In some embodiments, the texturing member 12 can have hierarchical features, for example, micro-scale features that further include nano-scale features thereupon. In some embodiments, the native surface 10 can be isotropic. In some embodiments, the native surface 10 can be anisotropic.

In some embodiments, the texturing member can be a film. In some embodiments, the texturing member can be a film with adhesive backing such that the texturing member can be applied directly to the native surface and then removed at a later time. In some embodiments, the texturing member can be a thin film, to which an adhesive or bonding member can be applied, such that the texturing member can be coupled to the native surface. In some embodiments, the coupling of the texturing member to the native surface can be facilitated by a crosslinking agent. In some embodiments, the coupling of the texturing member to the native surface can be facilitated by applying thermal energy.

In some embodiments, the disposition of the texturing member to the native surface can be facilitated by at least one of mechanical stretching, mechanical expansion, pneumatic expansion, chemical reaction, electromagnetic interaction, phase-inversion, gravitational force, centrifugal force, shear force, compressive force, tensile force, frictional force, air or fluid forces, electrical force, magnetic force, spring force, any other process. In some embodiments, the texturing member can be pre-treated prior to disposition to the native surface such that it retains at least one of residual stress, stored energy, other potential energies, or any combination thereof, in order to facilitate the creation of the texturing member during or after disposition of the texturing member to the native surface or to facilitate the adhesion of the texturing member to the native surface.

In some embodiments, the texturing member can be a part of a pre-formed structure. In some embodiments, the texturing member can be a drop-in liner. In some embodiments, the texturing member can be a scaffolding device. In some embodiments, the texturing member can be a fabric. In some embodiments, the texturing member can be formed or created and then disposed on the native surface. In some embodiments, the texturing member can be applied to the native surface, removed from the native surface, and reapplied to the same native surface or another native surface. In some embodiments, the texturing member can be applied, removed, and then reapplied any number of times without causing degradation of the native surface or texting member.

In some embodiments, the surface energy of the native surface 10 and/or the the texturing member 12 can be modified, for example, to enhance the adhesion of the texturing member 12 to the native surface 10. In some embodiments, such surface modification processes can include, for example, sputter coating, silane treatment, fluoro-polymer treatment, anodization, passivation, chemical vapor deposition, physical vapor deposition, oxygen plasma treatment, electric arc treatment, thermal treatment, any other suitable surface chemistry modification process or combination thereof.

In some embodiments, the solid features 112 can include micro-scale features such as, for example posts, pillars, spheres, nano-needles, pores, cavities, interconnected pores, grooves, ridges, spikes, peaks, interconnected cavities, bumps, mounds, particles, particle agglomerations, or any other random geometry that provides a micro and/or nano surface roughness. In some embodiments, the solid features 112 can include particles that have micro-scale or nano-scale dimensions which can be randomly or uniformly dispersed on a surface. Characteristic spacing between the solid features 112 can be about 1 mm, about 900 μm, about 800 μm, about 700 μm, about 600 μm, about 500 μm, about 400, μm, about 300 μm, about 200 μm, about 100 μm, about 90 μm, about 80 μm, about 70 μm, about 60 μm, about 50 μm, about 40 μm, about 30 μm, about 20 μm, about 10 μm, about 5 μm, 1 μm, or 100 nm, about 90 nm, about 80 nm, about 70 nm, about 60 nm, about 50 nm, about 40 nm, about 30 nm, about 20 nm, about 10 nm, or about 1 nm. In some embodiments, characteristic spacing between the solid features 112 can be in the range of about 100 μm to about 100 nm, about 30 μm to about 1 μm, or about 10 μm to about 1 μm. In some embodiments, characteristic spacing between solid features 112 can be in the range of about 100 μm to about 80 μm, about 80 μm to about 50 μm, about 50 μm to about 30 μm, about 30 μm to about 10 μm, about 10 μm to about 1 μm, about 1μm to about 90 nm, about 90 nm to about 70 nm, about 70 nm to about 50 nm, about 50 nm to about 30 nm, about 30 nm, to about 10 nm, or about 10 nm to about 1 nm, inclusive of all ranges therebetween.

In some embodiments, the solid features 112, for example solid particles can have an average dimension of about 200 μm, about 100 μm, about 90 μm, about 80 μm, about 70 μm, about 60 μm, about 50 μm, about 40 μm, about 30 μm, about 20 μm, about 10 μm, about 5 μm, 1μm, about 100 nm, about 90 nm, about 80 nm, about 70 nm, about 60 nm, about 50 nm, about 40 nm, about 30 nm, about 20 nm, about 10 nm, or about 1 nm. In some embodiments, the average dimension of the solid features 112 can be in the range of about 100 μm to about 100 nm, about 30 μm to about 10 μm, or about 20 μm to about 1 μm. In some embodiments, the average dimension of the solid feature 112 can be in the range of about 100 μm to about 80 μm, about 80 μm to about 50 μm, about 50 μm to about 30 μm, or about 30 μm to about 10 μm, or 10 μm to about 1 μm, about 1 μm to about 90 nm, about 90 nm to about 70 nm, about 70 nm to about 50 nm, about 50 nm to about 30 nm, about 30 nm, to about 10 nm, or about 10 nm to about 1 nm, inclusive of all ranges therebetween. In some embodiments, the height of the solid features 112 can be substantially uniform. In some embodiments, the surface of the texturing member 12 can have hierarchical features. For example, the solid features 112 can include micro-scale features that further include nano-scale features disposed thereupon or therein.

In some embodiments, the solid features 112 (e.g., particles) can be porous. In some embodiments, characteristic pore size (e.g., pore widths or lengths) of particles can be about 5,000 nm, about 3,000 nm, about 2,000 nm, about 1,000 nm, about 500 nm, about 400 nm, about 300 nm, about 200 nm, about 100 nm, about 80 nm, about 50 nm, about 10 nm, or about lnm inclusive of all ranges therebetween. In some embodiments, characteristic pore size can be in the range of about 200 nm to about 2 μm, or about 10 nm to about 1 μm inclusive of all ranges therebetween. In some embodiments, controlling the pore size, the length of pores, and the number of pores can allow for greater control of the impregnating liquid flow rates, product flow rates, and overall material yield.

In some embodiments, the impregnating liquid 120 is disposed on the surface of the texturing member 12 such that the impregnating liquid 120 impregnates the interstitial regions defined by the plurality of solid features 112, for example, pores, cavities, or otherwise inter-feature spacing defined by the surface of the texturing member 12 such that no air remains in the interstitial regions. The interstitial regions can be dimensioned and configured such that the surface remains impregnated by impregnating liquid 120 through capillarity. The impregnating liquid 120 disposed in the interstitial regions of the plurality of solid features 112 is configured to define a liquid-impregnated surface 111 such that a second roll off angle less than the first roll of angle (i.e., the roll of angle of the unmodified native surface 10). In some embodiments, the impregnating liquid 120 can have a viscosity at room temperature of less than about 1,000 cP, for example about 1 cP, 10 cP, 20 cP, 50 cP, about 100 cP, about 150 cP, about 200 cP, about 300 cP, about 400 cP, about 500 cP, about 600 cP, about 700 cP, about 800 cP, about 900 cP, or about 1,000 cP, inclusive of all ranges therebetween. In some embodiments, the impregnating liquid 120 can have viscosity of less than about 1 cP, for example, about 0.1 cP, 0.2 cP, 0.3 cP, 0.4 cP, 0.5 cP, 0.6 cP, 0.7 cP, 0.8 cP, 0.9 cP, or about 0.99 cP, inclusive of all ranges therebetween. In some embodiments, the impregnating liquid 120 can fill the interstitial regions defined by the solid features 112 such that the impregnating liquid 120 forms a layer at least about 5 nm thick above the plurality of solid features 112 of the texturing member 12. In some embodiments, the impregnating liquid 120 forms a layer at least about 100 nm thick above the plurality of solid features 112 of the texturing member 12. In some embodiments, the impregnating liquid 120 forms a layer at least about 1 um thick above the plurality of solid features 112 of the texturing member 12. In some embodiments, the plurality of solid features can have an average roughness, Ra, less than 0.8 um, for example, in compliance with the rules and regulations of a regulatory body (e.g., the Food and Drug Administration (FDA)).

The impregnating liquid 120 may be disposed in the interstitial regions defined by the solid features 112 using any suitable means. For example, the impregnating liquid 120 can be sprayed (e.g., air spray, thermal spray, plasma spray) or brushed onto the texturing member 12. In some embodiments, the impregnating liquid 120 can be applied to the texturing member 12 by filling or partially filling a container that contains the texturing member 12 within the volume of the container that is filled or partially filled. The excess impregnating liquid 120 is then removed from the container. In some embodiments, the excess impregnating liquid 120 can be removed by adding a wash liquid (e.g., water, surfactants, acids, bases, solvents, etc.), or a heated wash liquid to the container to collect or extract the excess liquid from the container or flowing the wash liquids over the surface of the container. In some embodiments, the excess impregnating liquid may be mechanically removed (e.g., pushed off the surface of the texturing member 12 with a solid object or fluid), absorbed off of the surface of the texturing member 12 using another porous material, or removed from the texturing member 12 via gravity or centrifugal forces. In some embodiments, the impregnating liquid 120 can be disposed by spinning the texturing member 12 (e.g., a container) in contact with the liquid (e.g., a spin coating process), and condensing the impregnating liquid 120 onto the surface of the texturing member 12. In some embodiments, the impregnating liquid 120 is applied by depositing a solution with the impregnating liquid and one or more volatile liquids (e.g., via any of the previously described methods) and evaporating away the one or more volatile liquids. In some embodiments, the solid materials may be removed in a wash process, and reapplied after the wash process.

In some embodiments, the impregnating liquid 120 can be applied using a spreading liquid that spreads or pushes the impregnating liquid along the surface of the texturing member 12. For example, the impregnating liquid 120 (e.g., ethyl oleate) and spreading liquid (e.g., water) may be combined in a container and agitated or stirred. The fluid flow within the container may distribute the impregnating liquid 120 around the container as it impregnates the solid features 112.

In some embodiments, the impregnating liquid 120 included in the liquid-impregnated surface 111, or impregnating liquid communicated to the liquid-impregnated surface 111, for example, from the liquid delivery mechanism 14, can be saturated with the material that the solid features 112 (e.g., any of the solid features described herein) are comprised of, such that the solid features 112 do not dissolve into the impregnating liquid 120.

In some embodiments, the impregnating liquid 120 can include silicone oil, fisheyes remover/eliminator, KE215-HP, Transtar 6737, Eastwood fish eye eliminator, a polydimethylsiloxane, a fluorosurfactant in combination with a polar liquid such as Dupont Capstone Fluorosurfactant FS-22, FS-30, FS-31, and FS-34, a fluorosilicone such as DOW Corning® FS 1265 fluid, siltech fluorosil, liquids that are emulsions such as a mineral oil-PFPE emulsion, PFPE-PEG emulsion, etc., a perfluorocarbon liquid, fluorinated vacuum oil, halogenated vacuum oil, greases, lubricants, (such as Krytox 1506 or Fromblin 06/6), a fluorinated coolant (e.g., perfluoro-tripentylamine sold as FC-70, manufactured by 3M), a high temperature heat transfer fluid (e.g. Galden HT, Novec fluids, etc.), an ionic liquid, a fluorinated ionic liquid that is immiscible with water, a silicone oil comprising PDMS, a fluorinated silicone oil such as, for example polyfluorosiloxane, or polyorganosiloxanes, a liquid metal, a synthetic oil, a vegetable oil, derivative of a vegetable oil, a mono- di- or triglyceride, an electro-rheological fluid, a magneto-rheological fluid, a ferro-fluid, a dielectric liquid, a hydrocarbon liquid such as mineral oil, polyalphaolefins (PAO), fluorinated glycine, fluorinated ethers, or other synthetic hydrocarbon co-oligomers, a fluorocarbon liquid, for example, polyphenyl ether (PPE), perfluoropolyether (PFPE), or perfluoroalkanes, a refrigerant, a vacuum oil, a phase-change material, a semi-liquid, polyalkylene glycol, esters of saturated fatty and dibasic acids, polyurea, grease, synovial fluid, bodily fluid, any other aqueous fluid, any other fluid, any other impregnating liquid described herein, any other suitable fluid, or any combination thereof. In some embodiments, the impregnating liquid 120 can include an ionic liquid. Such ionic impregnating liquids can include, for example, tetrachloroethylene (perchloroethylene), phenyl isothiocyanate (phenyl mustard oil), bromo benzene, iodobenzene, obromotoluene, alpha-chloronaphthalene, alpha-bromonaphthalene, acetylene tetrabromide, 1-butyl-3-methylimidazolium bis(trifluoromethylsulfonyl) imide (BMim), tribromohydrin (1,2,3-tribromopropane), tetradecane, cyclohexane, ethylene dibromide, carbon disulfide, bromoform, methylene iodide (diiodomethane), stanolax, Squibb's liquid petrolatum, p-bromotoluene, monobromobenzene, perchloroethylene, MCT oil, carbon disulfide, phenyl mustard oil, monoiodobenzene, triacetin, triglyceride of citric acid, alpha-monochloro-naphthalene, acetylene tetrabromide, aniline, butyl alcohol, isoamyl alcohol, n-heptyl alcohol, cresol, oleic acid, linoleic acid, amyl phthalate, any other ionic liquid and any combination thereof.

In some embodiments, the liquid-impregnated surface 111 can include non-toxic materials, for example impregnating liquid 120 and/or solid features 112 (e.g., solid particles used to form solid features such as, for example, wax) which are non-toxic to humans and/or animals. Such non-toxic liquid-impregnated surfaces can thereby be disposed on surfaces, for example the texturing member 12, which are configured to house products formulated for human use or consumption. Such products can include, for example food products, drugs (e.g., FDA approved drugs), or health and beauty products.

In some embodiments, any solvents used in the processing of any components of the liquid-impregnated surface 111, for example the solid surface, may remain in the liquid-impregnated surface in some concentration, and thus the solvents can also be chosen to be non-toxic. Examples of solvents that are non-toxic in residual quantities include ethyl acetate, ethanol, or any other non-toxic solvent.

The non-toxicity requirements can vary depending upon the intended use of the product in contact with the liquid-impregnated surface. For example, liquid-impregnated surfaces configured to be used with food products or products classified as drugs would be required to have a much higher level of non-toxicity when compared with products meant to contact only the oral mucosa (e.g., toothpaste, mouth wash, etc.), or applied topically such as, for example, health and beauty products (e.g., hair gel, shampoo, cosmetics, etc.).

In some embodiments, the liquid-impregnated surface 111 can include materials that are a U.S. Food and Drug Administration (FDA) approved direct or indirect food additive, an FDA approved food contact substance, satisfy FDA regulatory requirements to be used as a food additive or food contact substance, and/or is an FDA GRAS material. Examples of such materials can be found within the FDA Code of Federal Regulations Title 21, located at “http://www.accessdata.fda.gov/scripts/cdrh/cfdocs/cfcfr/cfrsearch.cfm”, the entire contents of which are hereby incorporated by reference herein. In some embodiments, the components of the liquid-impregnated surface 111, for example the impregnating liquid, can exist as a component of the food product disposed within the container. In some embodiments, the components of the liquid-impregnated surface 111 can include a dietary supplement or ingredient of a dietary supplement. The components of the liquid-impregnated surface 111 can also include an FDA approved food additive or color additive. In some embodiments, the liquid-impregnated surface 111 can include materials that exist naturally in, or are derived from plants and animals. In some embodiments, the liquid-impregnated surface 111 for use with food products includes solids or impregnating liquid that is flavorless or have a high flavor threshold of below 500 ppm, are odorless or have high odor threshold, and/or are substantially transparent.

In some embodiments, the materials included in the liquid-impregnated surface 111 can include an FDA approved drug ingredient, for example any ingredient included in the FDA's database of approved drugs, “http://www.access data.fda.gov/scripts/cder/drugsatfda/index.cfm”, the entire contents of which are hereby incorporated herein by reference. In some embodiments, the liquid-impregnated surface 111 can include materials that satisfy FDA requirements to be used in drugs or are listed within the FDA's National Drug Discovery Code Directory, “http://www.accessdata.fda.gov/scripts/cder/ndc/default.cfm”, the entire contents of which are hereby incorporated herein by reference. In some embodiments, the materials can include inactive drug ingredients of an approved drug product as listed within FDA's database, “http://www.accessdata.fda.gov/scripts/cder/ndc/default.cfm”, the entire contents of which are hereby incorporated herein by reference. In some embodiments, the materials can include any materials that satisfy the requirement of materials that can be used in liquid-impregnated surfaces configured to be used with food products, and/or include a dietary supplement or ingredient of a dietary supplement.

In such embodiments, the liquid-impregnated surface 111 can include materials which are FDA approved and satisfy FDA drug requirements, as listed within the FDA's National Drug Discovery Code Directory, and can also include FDA approved health and beauty ingredient, that satisfy FDA requirements for materials used in health and beauty products, satisfies FDA regulatory laws included in the Federal Food, Drug and Cosmetic Act (FD&C Act), or the Fair Packaging and Labeling Act (FPLA).

In some embodiments, the liquid-impregnated surface 111 can include materials that are an FDA approved health and beauty ingredient, that satisfy FDA requirements for materials used in health and beauty products, satisfies FDA regulatory laws included in the Federal Food, Drug and Cosmetic Act (FD&C Act), or the Fair Packaging and Labeling Act (FPLA). In some embodiments, the materials can include a flavor or a fragrance.

In some embodiments, the materials included in the liquid-impregnated surfaces 111 described can be flavorless or have high flavor thresholds below 500 ppm, and can be odorless or have a high odor threshold. In some embodiments, the materials included in the liquid-impregnated surface 111 can be substantially transparent. For example, the solid features 112 or impregnating liquid 120 can be selected so that they have substantially the same or similar indices of refraction. By matching their indices of refraction, they may be optically matched to reduce light scattering and improve light transmission. For example, by utilizing materials that have similar indices of refraction and have a clear, transparent property, a surface having substantially transparent characteristics can be formed. In some embodiments, the materials included in the liquid-impregnated surface 111 are organic or derived from organically-grown products. In some embodiments, the impregnating liquid 120 can include one or more additives. The additive can be configured, for example, to reduce the viscosity, vapor pressure, or solubility of the impregnating liquid. In some embodiments, the additive can be configured to increase the chemical stability of the liquid-impregnated surface 111, for example, the additive can be an anti-oxidant configured to inhibit oxidation of the liquid-impregnated surface. In some embodiments, the additive can be added to reduce or increase the freezing point of the liquid. In some embodiments, the additive can be configured to reduce the diffusivity of oxygen or CO₂ through the liquid-impregnated surface 111 or enable the liquid-impregnated surface 111 to absorb more ultra violet (UV) light, for example protect the product (e.g., any of the products described herein), disposed within a container on which the non-toxic liquid-impregnated surface 111 is disposed. In some embodiments, the additive can be configured to provide an intentional odor, for example a fragrance (e.g., smell of flowers, fruits, plants, freshness, scents, etc.). In some embodiments, the additive can be configured to provide color to the liquid-impregnated surface 111 and can include, for example a dye, or an FDA approved color additive. In some embodiments, the non-toxic liquid-impregnated surface 111 includes an additive that can be released into the product, for example, a flavor or a preservative.

In some embodiments, the materials included in any of the liquid-impregnated surface 111 can be organic or derived from organically-grown products. For example, the impregnating liquid 120 can include organic liquids that are often or sometimes non-toxic. Such organic liquids can, for example, include materials that fall within the following classes: lipids, vegetable oils (e.g., olive oil, light olive oil, corn oil, soybean oil, rapeseed oil, linseed oil, grapeseed oil, flaxseed oil, peanut oil, safflower oil, palm oil, coconut oil, or sunflower oil), fats, fatty acids, derivatives of vegetable oils or fatty acids, esters, terpenes, monoglycerides, diglycerides, triglycerides, alcohols, and fatty acid alcohols, inclusive of all combinations thereof. Examples of vegetable oils suitable for use as impregnating liquid 120 are described in Gunstone, F., “Vegetable Oils in Food Technology: Composition, Properties and Uses: 2nd Ed.”, Wiley, John and Sons Inc., Pub. May 2011, the contents of which are hereby incorporated by reference herein in their entirety.

In some embodiments, the liquid-impregnated surface 111 described herein can include organic solids and/or liquids that are non-toxic and fall within the following classes: lipids, waxes, fats, fibers, cellulose, derivatives of vegetable oils, esters (such as esters of fatty acids), terpenes, monoglycerides, diglycerides, triglycerides, alcohols, fatty acid alcohols, ketones, aldehydes, proteins, sugars, salts, minerals, vitamins, carbonate, ceramic materials, alkanes, alkenes, alkynes, acyl halides, carbonates, carboxylates, carboxylic acids, methoxies, hydroperoxides, peroxides, ethers, hemiacetals, hemiaketals, acetals, ketals, orthoesters, orthocarbonate esters, phospholipids, lecithins, any other organic material or any combination thereof. In some embodiments, any of the non-toxic liquid-impregnated surfaces described herein can include non-toxic materials that are boron, phosphorous, or sulfur containing compound. Some examples of food-safe impregnating liquids are MCT (medium chain triglyceride) oil, ethyl oleate, methyl laurate, propylene glycol dicaprylate/dicaprate, or vegetable oil, glycerine, squalene, or vegetable oils. In some embodiments, any of the non-toxic liquid-impregnated surfaces can include inorganic materials, for example ceramics, metals, metal oxides, silica, glass, plastics, any other inorganic material or combination thereof. In some embodiments, any of the non-toxic liquid-impregnated surfaces described herein can include, for example preservatives, sweeteners, color additives, flavors, spices, flavor enhancers, fat replacers, and components of formulations used to replace fats, nutrients, emulsifiers, surfactants, bulking agents, cleansing agents, depilatories, stabilizers, emulsion stabilizers, thickeners, flavor or fragrance, an ingredient of a flavor or fragrance, binders, texturizers, humectants, pH control agents, acidulants, leavening agents, anti-caking agents, anti-dandruff agents, anti-microbial agents, antiperspirants, anti-seborrheic agents, astringents, bleaching agents, denaturants, depilatories, emollients, foaming agents, hair conditioning agents, hair fixing agents, hair waving agents, absorbents, anti-corrosive agents, anti-foaming agents, anti-oxidants, anti-plaque agents, anti-static agents, binding agents, buffering agents, chelating agents, cosmetic colorants, deodorants, detangling agents, emulsifying agents, film formers, foam boosting agents, gel forming agents, hair dyeing agents, hair straightening agents, keratolytics, moisturizing agents, oral care agents, pearlescent agents, plasticizers, refatting agents, skin conditioning agents, smoothing agents, soothing agents, tonics, and/or UV filters.

In some embodiments, the liquid-impregnated surface 111 can include non-toxic materials having an average molecular weight in the range of about 100 g/mol to about 600 g/mol, which are included in the Springer Material Landolt-Bornstein database located at “http://www.springermaterials.com/docs/index.html”, or in the MatNavi database located at “www.mits.nims.go.jp/index_en.html”. In some embodiments, the impregnating liquid 120 can have a boiling point greater than 150° C. or preferably 250° C., such that the impregnating liquid 120 is not classified as volatile organic compounds (VOC's). In some embodiments, the impregnating liquid 120 can have a density that is substantially equal to the density of the product.

The ratio of the solid features 112 (e.g., particles) to the impregnating liquid 120, can be configured to ensure that little or no portion of the solid features 112 protrude above the impregnating liquid-contact liquid interface. In some embodiments, the liquid-impregnated surface 111 can have an “emerged area fraction” ϕ, which is defined as a representative fraction of the projected surface area of the liquid-impregnated surface 112, corresponding to non-submerged solid (non-submerged by the impregnating liquid. This portion can be in contact with a contact liquid) at room temperature, of less than about 0.50, about 0.50, about 0.30, about 0.25, about 0.20, about 0.15, about 0.10, about 0.05, about 0.01, or less than about 0.005. In some embodiments, ϕ can be greater than about 0.001, about 0.005, about 0.01, about 0.05, about 0.10, about 0.15, or greater than about 0.20. In some embodiments, ϕ can be in the range of about 0 to about 0.25. In some embodiments, ϕ can be in the range of about 0 to about 0.01. In some embodiments, ϕ can be in the range of about 0.001 to about 0.25. In some embodiments, ϕ can be in the range of about 0.001 to about 0.10. In some embodiments, a low can be achieved using surface textures that are substantially pointed, caved, or are rounded. By contrast, surface textures that are flat may result in higher ratios, with too much solid material exposed at the surface.

In some embodiments, the liquid-impregnated surface 111 can have a spreading coefficient Sₒₑ₍ᵥ₎<0, where Sₒₑ₍ᵥ₎ is spreading coefficient, defined as γₑᵥ-γₑₒ-Γₒᵥ, where γ is the interfacial tension between the two phases designated by subscripts, said subscripts selected from e, v, and o, where e is a non-vapor phase (e.g., liquid or semi-solid) external to the surface and different from the impregnating liquid, v is vapor phase external to the surface (e.g., air), and o is the impregnating liquid 120.

100591 In some embodiments, the solid features 112 provide stable impregnation of the impregnating liquid 120 therebetween or therewithin. In order for the solid features to provide stable impregnation of the impregnating liquid 120 therebetween or therewithin, the solid feature material and texture, and the impregnating liquid material must be selected such that the following interaction properties hold: (i) θ_{os(v),receding}<θ_{c} and (ii) θ_{os(c),receding}<θ_{c}, where θ_{c}=cos⁻¹((1−ϕ)/(r−ϕ)) is the critical contact angle, r is the Wenzel roughness of the surface of the texturing member 12, and where θ_{os(e),receding} is receding contact angle of the impregnating or encapsulating liquid 120 (e.g., oil, subscript ‘o’)on a smooth surface comprised of the same material as the solid features 112 (subscript ‘s’) in the presence of the contact liquid CL (subscript ‘e’) and θ_{os(v),receding} is receding contact angle of the impregnating liquid 120 (e.g., oil, subscript ‘o’) on a smooth surface comprised of the same material as the solid features 112 (subscript ‘s’) in the presence of air or other external vapor phase (subscript ‘v’), In some embodiments, it is sufficient for the following simplified conditions to hold: (i) θ_{os(v),receding}<θ*_{c} and θ_{os(e),receding}<θ*_{c}, where θ*_{c}=cos⁻¹(1/r). θ*_{c}=cos≈θ_{c} when ϕ is small.

In some embodiments, the solid features 112 provide stable impregnation of the impregnating liquid 120 therebetween or therewithin in the presence of air, such that θ_{os(v), receding}<θ_{c}. where θ_{c} is critical contact angle. In some embodiments, the solid features 112 can be selected such that a thin Van der Waals film (typically less than 100 nm at equilibrium), can remain stably spread over the features, causing the surface to be fully encapsulated (ϕ=0). For such a Van der Waals film to remain stable in air, the solid features and impregnating liquid must be slected which satisfy θ_{os(v),receding}=0, and to ensure that the film remains stable beneath the contact liquid CL, it must also hold that (i) θ_{os(e),receding}=0. In some embodiments it is desirable that (i) θ_{s(v), receding}>0 and (ii) θ_{os(e), receding}>0 both hold. In some embodiments, both θ_{os(v), receding}>0 and θ_{os(e), receding}>0, such that there is not a thin Van der Waals film spread over the surface features, and thus ϕ>0. In such instances the surface must be designed such that (i) θ_{os(v),receding}<θ_{c} and (ii) θ_{os(e),receding}<θ_{c} or (i) θ_{os(v),receding}<θ*_{c} and (ii) θ_{os(e),receding}<θ*_{c} hold. Furthermore, in some embodiments, it can be desirable that that the textures be selected such that ϕ is low. In some embodiments, a low ϕ can be achieved using surface textures that are substantially pointed, caved, or are rounded.

In some embodiments, the liquid-impregnated surface 111 can have advantageous droplet roll-off properties that minimize the accumulation of the contacting liquid CL on the surface. Without being bound to any particular theory, in some embodiments, a roll off angle, which is the angle of inclination of the liquid-impregnated surface 111 at which a droplet of contact liquid placed on the texturing member begins to move can be less than about 30°, less than about 25°, or less than about 20° for a specific volume of contact liquid. In such embodiments, the roll off angle can vary with the volume of the contact liquid included in the droplet, but for a specific volume of the contact liquid, the roll off angle remains substantially the same.

In some embodiments, the impregnating liquid 120 can include one or more additives to prevent or reduce evaporation of the impregnating liquid 120. For example, a surfactant can be added to the impregnating liquid 120. In some embodiments, the surfactants used to prevent or reduce evaporation of the impregnating liquid 120 can include, but are not limited to, docosenoic acid, trans-13-docosenoic acid, cis-13-docosenoic acid, nonylphenoxy tri(ethyleneoxy) ethanol, methyl 12-hydroxyoctadecanate, 1-Tetracosanol, fluorochemical “L-1006”, and any combination thereof. Examples of surfactants described herein and other surfactants which can be included in the impregnating liquid can be found in White, I., “Effect of Surfactants on the Evaporation of Water Close to 100 C.” Industrial & Engineering Chemistry Fundamentals 15.1 (1976): 53-59, the content of which is incorporated herein by reference in its entirety. In some embodiments, the additives can include C₁₆H₃₃COOH, C₁₇H₃₃COOH, C₁₈H₃₃COOH, C₁₉H₃₃COOH, C₁₄H₂₉OH, C₁₆H₃₃OH, C₁₈H₃₇OH, C₂OH₄₁OH, C₂₂H₄₅OH, CrH₃₅COOCH₃, C₁₅H₃₁COOC₂H₅, C₁₆H₃₃OC₂H₄OH, C₁₈H₃₇OC₂H₄OH, C₂OH₄₁OC₂H₄OH, C₂₂H₄₅OC₂H₄OH, Sodium docosyl sulfate (SDS), poly(vinyl stearate), Poly (octadecyl acrylate), Poly(octadecyl methacrylate) and any combination thereof Further examples of additives can be found in Barnes, G. T., “The potential for monolayers to reduce the evaporation of water from large water storages”, Agricultural Water Management 95.4 (2008): 339-353, the content of which is hereby incorporated herein by reference in its entirety.

The liquid delivery mechanism 14 is configured to transfer the impregnating liquid 120 to the interstitial regions between the solid features 112. In this manner, the liquid delivery mechanism 14 can be configured to maintain a replenishing supply of the impregnating liquid 120 to the interstitial regions such that any impregnating liquid 120 lost from the liquid-impregnated surface 111 is replaced by fresh impregnating liquid 120 by the liquid delivery mechanism 14. In some embodiments, the liquid delivery mechanism 14 can include a reservoir containing a supply of impregnating liquid 120 and fluidically coupled to the interstitial regions such that a supply of impregnating liquid 120 can flow into the interstitial regions by capillary action. In some embodiments, the reservoir of impregnating liquid 120 can be at a higher pressure than the interstitial regions such that the supply of impregnating liquid is forced into the interstitial regions by the pressure differential. In some embodiments, the liquid delivery mechanism can include a pumping mechanism configured to transfer impregnating liquid from the reservoir to the interstitial regions.

For example, in some embodiments, the liquid delivery mechanism 14 can include a reservoir fluidically coupled to the interstitial regions of a texturing member 12 such that a replenishing supply of impregnating liquid 120 can be communicated from the reservoir to the interstitial regions. In some embodiments, the reservoir is not spatially-proximate to the liquid-impregnated surface 111. In some embodiments, the reservoir is maintained at a higher elevation than the liquid-impregnated surface 111 such that gravitational forces cause the communication of a replenishing supply of impregnating liquid 120 to the fluidically-coupled interstitial regions.

In some embodiments, a pumping mechanism can be used to pump the impregnating liquid 120 from the reservoir into the interstitial regions. In some embodiments, a liquid delivery mechanism 14 can be used to deliver both an initial supply and replenishing supply of impregnating liquid 120 to the interstitial regions of the solid features 112.

In some embodiments, an adhesive material is disposed to a first surface of the texturing member 12, in contact with the native surface 10 in order to facilitate disposition of the texturing member 12 to the native surface 10. In some embodiments, adhesive materials can include but are not limited to tar, rubber cement, polymers, polyvinyl acetate, pressure-sensitive adhesives, polychloroprene, ethylene-vinyl acetate, polyester resin, polyurethane resin, thermoset epoxies, polyimides, urethanes, cellulose nitrate, cellulose acetate butyrate, methyl cellulose, ethyl cellulose, polyvinyl alcohol, polyvinyl butyral, polyvinyl formal, polyvinyl chloride, polyvinyl ether, styrene-butadiene, styrene-diene-styrene, polyisobutylene, acrylonitrile-butadiene, polysulfide, silicone, phenolic resin, resorcinol resin, polyamide, polybenzimidazole, polyquinoxaline, polyethylenimine, polypropylene hot melt, ethylene-vinyl acetate, ethylene-ethyl acrylate, any other adhesive material and any combination thereof. In some embodiments, the adhesive material or combination of materials may require the application of a cross-linking agent, electrical current, thermal energy, cold, pressure, solvent, friction, enzyme, surfactant, emulsifier, laminate bonding agent, suspended solid particles, catalyst, polymerization initiator, moisture, combustion, surface pre-treatment, other adhesive aiding materials or any combination thereof

The liquid-impregnated surface 111 can be in contact with a contact liquid CL such that the contact liquid CL moves easily over the liquid-impregnated surface 111. The contact liquid CL, can be any liquid that is slightly miscible or immiscible with the impregnating liquid 120 such as, for example, water, edible liquids or aqueous formulations (e.g., ketchup, mustard, mayonnaise, honey, etc.), environmental fluids (e.g., sewage, rain water), bodily fluids (e.g., urine, blood, stool), or any other fluid. In some embodiments, the contact liquid CL can be a food product or a food ingredient such as, for example, a sticky, highly viscous, and/or non-Newtonian fluid or food product. Such food products can include, for example, candy, chocolate syrup, mash, yeast mash, beer mash, taffy, food oil, fish oil, marshmallow, dough, batter, baked goods, chewing gum, bubble gum, butter, peanut butter, jelly, jam, dough, gum, cheese, cream, cream cheese, mustard, yogurt, sour cream, curry, sauce, ajvar, currywurst sauce, salsa lizano, chutney, pebre, fish sauce, tzatziki, sriracha sauce, vegemite, chimichurri, HP sauce/brown sauce, harissa, kochujang, hoisan sauce, kim chi, cholula hot sauce, tartar sauce, tahini, hummus, shichimi, ketchup, mustard, pasta sauce, Alfredo sauce, spaghetti sauce, icing, dessert toppings, or whipped cream, liquid egg, ice cream, animal food, any other food product or combination thereof. In some embodiments, the contact liquid CL can include a topical or oral drug, a cream, an ointment, a lotion, an eye drop, an oral drug, an intravenous drug, an intramuscular drug, a suspension, a colloid, or any other material form and can include any drug included within the FDA's database of approved drugs. In some embodiments, the contact liquid CL can include a health and beauty product, for example, toothpaste, mouth washes, mouth creams, denture fixing compounds, any other oral hygiene product, sun screens, antiperspirants, anti-bacterial cleansers, lotions, shampoo, conditioner, moisturizers, face washes, hair-gels, medical fluids (e.g., anti-bacterial ointments or creams), any other health or beauty product, and or any combination thereof. In some embodiments, the contact liquid CL can include any other non-Newtonian, thixotropic or highly viscous fluid, for example, laundry detergent, paint, oils, glues, waxes, petroleum products, fabric softeners, industrial solutions, or any other contact liquid CL. Additional examples of liquid-impregnated surfaces, methods of making liquid-impregnated surfaces and applications thereof, are described in U.S. Patent Publication No. 2014/0314975 entitled “Methods and Articles for Liquid-Impregnated Surfaces with Enhanced Durability,” filed Mar. 17, 2014, the entire contents of which are hereby incorporated by reference herein.

### Mobile Liquid

In some embodiments, it may be desirable to apply a liquid to a surface that has little or no texture. The problem with applying a liquid to a surface to provide lubrication in the absence of texture is that, unless certain criteria described herein are satisfied, the only way to maintain lubricity for any significant period of time is to apply a thick layer of liquid. However, because all or nearly all of the liquid will be quickly stripped from the smooth surface or drained under gravity, applying the amount of liquid necessary to maintain lubricity can result in high-levels of liquid in the product (contacting phase), which could result in significant issues, including compromised product properties. Furthermore, once most of the liquid is removed, the remaining liquid layer can become unstable, which leads to a surface that is not slippery (unless certain criteria described herein are satisfied). Furthermore, depending on the price of the liquid, applying a thick layer of lubricant can also be prohibitively expensive. Therefore, in some embodiments it can be desirable to maintain a lubricious surface with a thin layer of liquid, which will be more cost effective and result in minimal product contamination.

In addition, because some liquid is removed or otherwise drained away from the surface, it is typically necessary to resupply liquid to maintain the lubricity of the surface for further use. Failure to resupply liquid can result in diminished lubricity and reduced shedding speeds. In some instances, failure to resupply liquid may result in an entirely exposed solid surface and a complete breakdown in performance. In some embodiments, a calibrated resupply mechanism can be configured to maintain a thin, lubricious layer of liquid that enables sufficient shedding speed without over-supplying liquid.

The speed at which a product can slide increases with the slip length of the surface, b. The slip length, b, for a stable liquid surface is given by b=(C*h+t)*μ_{product}/μ₀, where h is the thickness of the film of liquid stabilized between the textures by capillary forces, or stabilized by Van Der Waals forces, as described herein, and t is the thickness of a layer of mobile liquid that is not stabilized by capillary forces or by Van der Waals forces. C is a constant between 0 and 1 (approaching 1 if textures are sparse). Increasing the thickness of the coating, h+t, by adding mobile liquid of thickness, t, therefore increases the slip length, which increases the mobility of the liquid-impregnated, or lubricious surface. The equation for slip length can be reorganized as b=(C*h)*μ_{product}/μ₀+M*μ_{product}. The contribution to the slip length due to the mobile excess liquid, is M*μ_{product}, where M=t/μ₀. We will henceforth refer to M as the mobility parameter for the mobile liquid.

Nevertheless, the above equation is only a valid estimate of average slip length if the product cannot pin to the surface, or valid up until such pinning occurs. For example, a smooth surface with a layer of mobile liquid of thickness, t, but with h=0 (i.e., no stabilized layer of liquid, beneath the mobile liquid). In typical dynamic environments (e.g., mixing or pipeflow, or vibration from transportation), fluctuations in pressure within the moving product can cause the mobile liquid-product interface to become curved, and thus the product will come into contact with the solid surface beneath and become pinned. Gradually this area of contact will expand and the lubrication effect will be lost. In order to prevent such pinning, the underlying surface can be engineered with a texture or chemistry that (1) can stably contain liquid beneath the product, and (2) has ϕ that low enough that the product cannot become pinned. In some embodiments the first criteria can be satisfied if cosθ_{os(e),receding}<(1−ϕ)/(r−ϕ)=θ_{c}. (cosθ_{os(e),receding}<1/r=θ_{c*} is a reasonable approximation when ϕ is low), where r is the Wenzel roughness of the surface of the texturing member 12, and where θ_{os(e),receding} is receding contact angle of the impregnating or encapsulating liquid 120 (e.g., oil, subscript ‘o’) on a smooth surface comprised of the same material as the solid features 112 (subscript ‘s’) in the presence of the contact liquid CL (subscript ‘e’).

In some embodiments, it may be advantageous to apply a slippery coating to a surface with little or no texture. For example, in high shear environments with highly viscous or abrasive liquids, creating a surface with the precise texture and surface chemistry to stably contain an appropriate impregnating liquid and also maintain low can be difficult and expensive, rendering such texture non-viable from an economic perspective. Furthermore, a texture, however carefully designed, can become exposed to the elements and erode over time in a harsh environment, such as that of a high-shear mixing tank. Implementing a liquid-impregnated surface with sub-optimal texture, or utilizing a texture that has been compromised by environmental conditions, can lead to pinning and diminished performance. By contrast, in some embodiments, a smooth surface with engineered surface chemistry can have fewer durability issues because there are no features to wear down. In short, there may be circumstances where a traditional liquid-impregnated surface with a solid texture is not desirable and where it may be beneficial to apply a liquid to a surface with little or no texture.

On a surface with little to no texture, however, alternative approaches can be taken to ensure the surface remains stable under pressure fluctuations. Specifically, the surface can be designed that (1) maintains a stable layer of liquid beneath the product, and (2) has ϕ that is low enough that product does not become irreversibly pinned to the surface. Without texture to satisfy (1), the solid-liquid combination can be designed such that there remains a thermodynamically stable layer of the lubricant tightly adhered to the surface by Van der Waals forces, even under high sheers stresses and pressure fluctuations. For example, a completely stable layer that exhibits no pinning can be achieved by choosing solid-liquid combinations such that cosθ_{os(e),receding}=0 and cosθ_{os(v),receding}=0. In some embodiments, it can be even more desirable (greater stability) with combinations for which cosθ_{os(e),advancing} is also low (e.g. <20° or <10° or <5° or <2°) and most desirable if cosθ_{os(e),advancing}=0° is also satisfied. This latter condition is equivalent to the requirement that Sₒₛ₍ₑ₎≥0, where Sₒₛ₍ₑ₎ is the spreading coefficient of the liquid on the solid in the presence of the contact liquid. In such cases, a wetting film will never become unstable beneath the product.

In cases where cosθ_{os(e),receding} is non zero, but still very low (e.g. <20° or <10° or <5° or <2°), the lubricating layer can remain stable and slippery over most (at least 90%) of the surface, even after significant shear (e.g. from high speed mixing in a tank or flow through a pipe). Thus, there will be some pinning of product. In such cases it is possible to achieve much thinner films (e.g. t<10 μm) that remain slippery even after significant shearing or pressure fluctuations. The above approach can be used to allow the coatings to withstand high speed mixing for several hours. Furthermore, as described herein, without a low enough contact angle (cosθ_{os(e),receding}) a thin film can de-wet the surface beneath the product to expose a higher fraction of the solid beneath and more product will be pinned as a result.

In some embodiments, the thickness for a lubricating liquid can depend on a number of factors, including viscosity of the lubricant. Other factors include the price of the liquid. Where expensive or specialty liquids are being used, economic viability may require using less liquid. Another consideration is whether any amount of liquid triggers issues of compatibility with product. Finally, regulations governing the product may impose limitations on the amounts of liquid that can be used. In some embodiments, the thickness of the coating can be less than about 2 microns, less than about 10 microns, less than about 50 microns, less than about 100 microns, or less than about 200 microns. In some embodiments, the thickness of the coating can be less than about 500 microns, less than about 750 microns, or less than about 1,000 microns. In some embodiments, the distribution of liquid across the surface is not uniform.

In some embodiments, it may be desirable to have a mobility parameter that is large enough to provide sufficient lubricity to the surface, but sufficiently low that the excess liquid does not rapidly deplete from the surface under gravity or high shear environments such as mixing. In some embodiments, the mobility parameter M can be at least about 0.005 μm/cP, at least about 0.01 μm/cP, at least about 0.05 μm/cP, at least about 0.1 μm/cP, or at least about 1 μm/cP, but less than about 5 μm/cP, or less than about 10 μm/cP or less than about 50 μm/cP, inclusive of all ranges and sub-ranges therebetween.

As described herein, one aspect of having a liquid on a smooth surface is that at least a portion of the liquid will be mobile over the surface. The parameters of the mobility can depend on the properties of the liquid, properties of the surface, properties of the product (contacting phase), and other environmental conditions. For example, the speed at which the product moves depends on its viscosity, average thickness, and how much that thickness is reduced when the liquid is exposed to a product under conditions such as mixing, which can create shear and pull liquid away from the wall. Furthermore, the readiness that external forces, shearing, mixing etc., can pull, emulsify, or dissolve liquid from the surface depends on the liquid and product's viscosity and chemistries, and their interfacial tensions, as well as initial thickness of the coating. In addition, the mobility of the liquid may depend on the product. Where, for example, the product is emptied, it may pull some of the liquid off of the surface. However, provided the conditions of cosθ_{os(e),receding}=0 and cosθ_{os(v),receding}=0 are met, a thin, thermodynamically stable layer of the lubricant (usually less than 100 nm) that is substantially less mobile, and remains tightly adhered to the surface by Van der Waals forces, even under high sheer stresses and pressure fluctuations. Where θ_{os(e),receding} is receding contact angle of the impregnating or encapsulating liquid (e.g., oil, subscript ‘o’) on the smooth surface (subscript ‘s’) in the presence of the contact liquid CL (subscript ‘e’), and θ_{os(v),receding} is receding contact angle of the encapsulating liquid (e.g., oil, subscript ‘o’) on the smooth surface (subscript ‘s’) in the presence of the vapor phase (e.g. air, subscript ‘v’).

While the liquid can be at least partially removed from the smooth surface, the surface chemistry and the liquid can be selected such that the surface maintains sufficient slipperiness through evacuation of the product to allow the product to de-wet. In some embodiments, sufficient liquid (e.g., impregnating liquid or encapsulating liquid) will survive mixing or other high-shear conditions to allow for product evacuation with little or no product sticking to the surface.

In some embodiments, the combination of liquid and solid surface can be engineered and/or selected in view of the product. In some cases, it may be useful to use a single liquid to form the lubricating layer. In others, it may be beneficial to use combination of liquids to achieve the desired metrics, including thickness, performance, etc. Combining liquids might be useful where, for example, one of the liquids is expensive, blending it with another, lower-cost liquid can reduce the overall price of the coating. In addition, it might be useful to include additives to modify the properties of the liquid. For example, in some embodiments, it might be possible to reduce the thickness of the liquid layer(s), by using lower viscosity liquids. However, such liquids can be volatile, and therefore undesirable. Additives, however, can reduce the volatility.

As described herein, mobile liquids can be used to create durable, slippery, surfaces in the context of liquid impregnated surfaces formed using textured surfaces. In such cases, it is possible to create a liquid impregnated surface by applying excess impregnating liquid that is mobile over the solid features. In such cases, the mobile excess liquid (i.e., the portion above the features) may behave like liquid on a smooth surface. In other words, as long as the appropriate thermodynamic conditions are satisfied (preferential wetting with a sufficiently low receding contact (i.e. cosθ_{os(e),receding}<θ_{c} or cosθ_{os(e),receding}<θ_{c*}), the excess mobile liquid can provide a slippery surface over and above the features. However, as in the context of a liquid on a smooth surface, the designed thickness of the excess mobile liquid film can depend on factors discussed above, and the desire for a high-performance lubricating layer can be balanced with concerns of cost, product compatibility, and regulatory context. In some embodiments, a thin mobile excess layer will be desirable. Similarly, the mobility or speed with which the excess liquid moves over the solid structure will be determined by the characteristics of the liquid.

In some embodiments, once the excess mobile liquid has been removed, the residual liquid remains trapped in the features of the liquid-impregnated surface through capillary forces. In some embodiments, the liquid can be mobile both over and through the texture. In such cases, the capillary forces in the texture can slow the movement of the liquid within the matrix of solid features (as compared to the liquid above the matrix), and only allow that movement to be tangential to the surface. Nevertheless, mobility through the features can depend upon the characteristics of the textured surface, the liquid, and the product. In some instances, the product might draw or otherwise pull the liquid through the features through mixing or evacuation.

### Durability Enhancement

As described herein, the impregnating or encapsulating liquid included in a liquid-impregnated or liquid-encapsulated surface can become entrained in a contact liquid (e.g., any of the contact liquids described herein), which is contacting the liquid-impregnated or liquid-encapsulated surface. The definition of “entrainment” hereinafter refers to the loss of the impregnating liquid from the liquid-impregnated surface due to the shear stress of the contact liquid, which may or may not be miscible with the impregnating liquid. This shear stress results in a flow of impregnating or encapsulating liquid and any mobile excess liquid at a combined flow rate Q_{f} described before herein, and this causes the liquid to be gradually depleted from the liquid-impregnated or liquid-encapsulated surface. The portion of the flow rate of mobile excess liquid is much greater that the portion of the flow rate of fluid trapped by capillary forces or Van der Waals forces, because the capillary forces or Van der Waals forces create a resistance to flow that counters the shear forces provided the contact liquid. In some embodiments, the impregnating liquid and mobile liquid can be depleted by gradual dissolution into the contact liquid or by evaporation. In some embodiments, the impregnating liquid can be drained via gravitation forces or buoyant forces (only flowing tangential to the surface). To increase durability of the liquid impregnated or liquid encapsulated surface 111, the extent of dissolution and/or evaporation of the impregnating liquid can be minimized, the quantity of impregnating liquid entrained in the contact liquid can be reduced, the amount of drainage by gravitational or buoyant forces can be reduced, and/or the impregnating liquid can be continuously or periodically replenished.

In some embodiments, a liquid delivery mechanism can be fluidically coupled to a liquid-impregnated surface and configured to transfer impregnating liquid to interstitial regions between the solid features included in the liquid-impregnated surface. In some embodiments, the liquid delivery mechanism can include a reservoir of impregnating liquid. The reservoir can be fluidically coupled to the liquid impregnated surface to provide a continuous replenishing supply of the impregnating liquid.

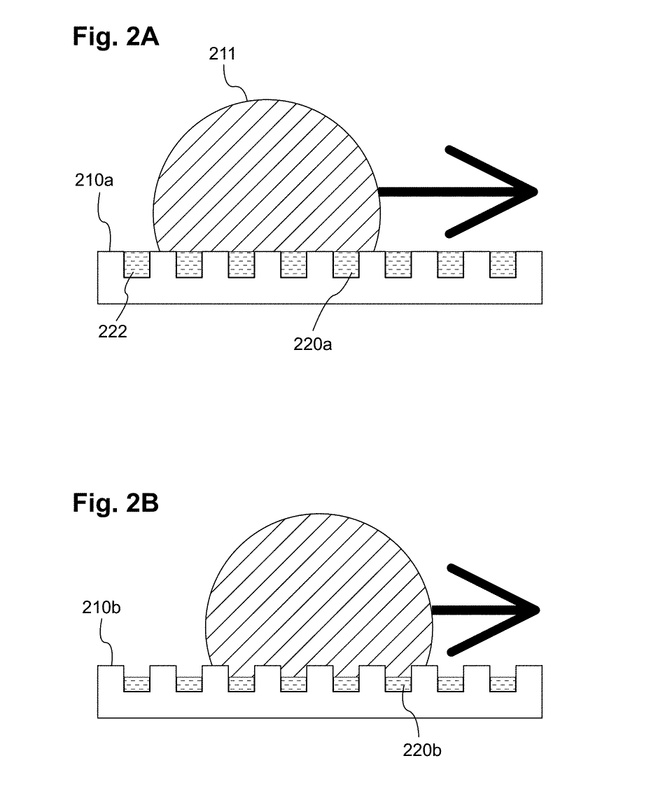

In some instances, capillarity or Van der Waals forces slow the depletion of impregnation liquid or encapsulating liquid, but do not completely stop the depletion. FIG. 2A shows a liquid-impregnated surface 210a onto which a droplet or blob 211 of a contact liquid is disposed. The liquid-impregnated surface 210a has interstitial regions 220a substantially impregnated with impregnating liquid 222, such that the contact area between the droplet 211 and the solid features is reduced and the lubricity of the liquid-impregnated surface 210a is increased relative to the native surface. FIG. 2B shows a liquid-impregnated surface 210b onto which the same droplet 211 of liquid is disposed. However, as shown in FIG. 2b, the liquid-impregnated surface 210b has interstitial regions 220b that are only partially filled with the impregnating liquid 222, such that the surface contact area of the droplet 211 is increased and the lubricity of the liquid-impregnated surface 210b is reduced relative to the liquid-impregnated surface 210a, depicted in FIG. 2A.

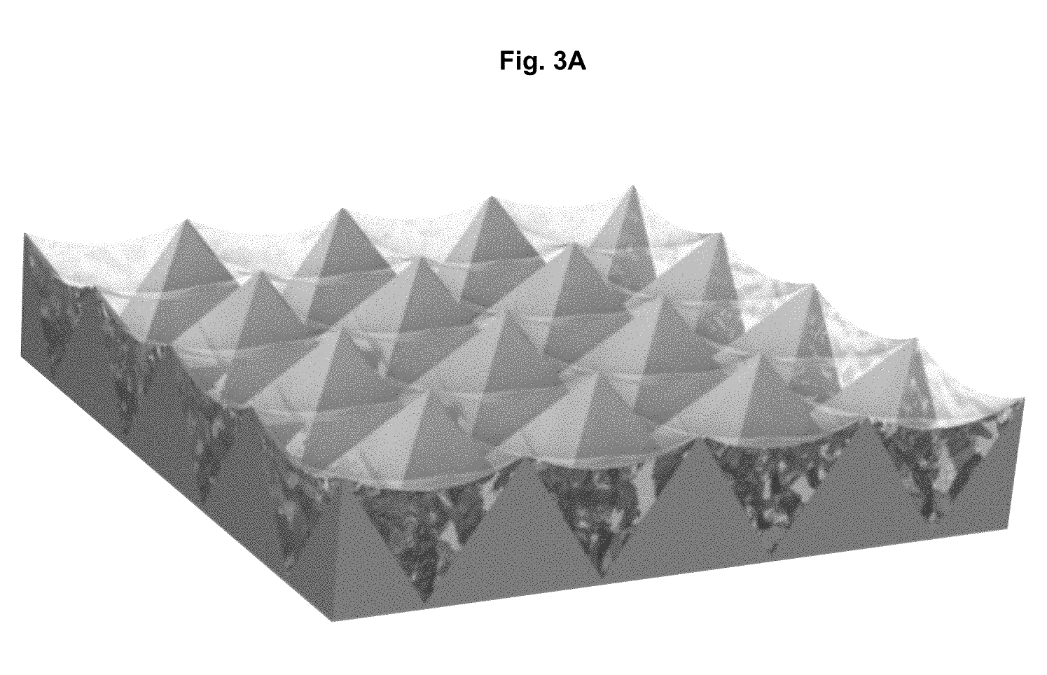

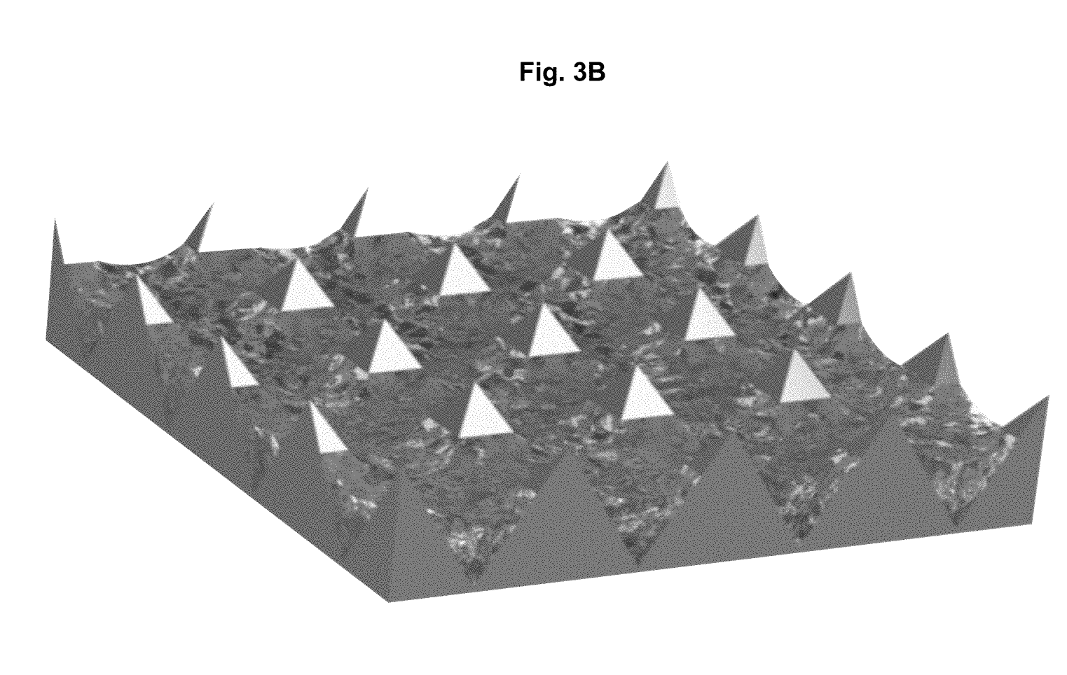

FIG. 3A shows a lower-ϕ (lower-phi) liquid-impregnated surface for which solid features disposed to the texturing member are substantially submerged or topped by the impregnating liquid, causing there to be a lower surface contact area. FIG. 3B shows a lower-ϕ (higher-phi) liquid-impregnated surface for which solid features disposed to the texturing member significantly extend through the impregnating liquid, increasing the potential surface contact area. In some embodiments, texturing members with a higher-ϕ result in a higher roll off angle. In some embodiments, texturing members with a lower-ϕ result in a lower roll off angle. Without being bound to any particular theory, in some embodiments, the difference between an initial slip length and a second slip length after appreciable depletion of impregnating liquid for the same texturing member and liquid-impregnated surface configuration can be reduced by replenishing the impregnating liquid to the interstitial regions such that impregnating liquid extends appreciably beyond the solid surfaces. In some embodiments, this replenishing supply of impregnating liquid can be supplied from a fluidically-coupled reservoir. In some embodiments, communication of the replenishing supply of impregnating liquid from the reservoir to the interstitial regions of the liquid-impregnated surface on the texturing member can be aided by a pumping device. Further, the communication of the replenishing supply of impregnation liquid can be metered. In other words, the communication of impregnation liquid can be selective and controlled. In some embodiments, the selective and controlled communication of impregnation liquid can be initiated manually by an operator at pre-set temporal intervals. In some embodiments, the selective and controlled communication of impregnation liquid can be initiated manually by an operator in response to depletion of impregnation liquid from the interstitial regions, as measured by a relative increase in time needed for the liquid to move across the liquid-impregnated surface. In other words, the time needed for a contact liquid to drain from a tank comprising said liquid-impregnated surface or the time needed for a contact liquid to move between two points within a pipeline or the time needed for a contact liquid to move across a surface of a non-enclosed container. In some embodiments, the selective and controlled communication of impregnation liquid can be initiated automatically by a programmable logic controller device based upon a sensor, meter, or other feedback device.

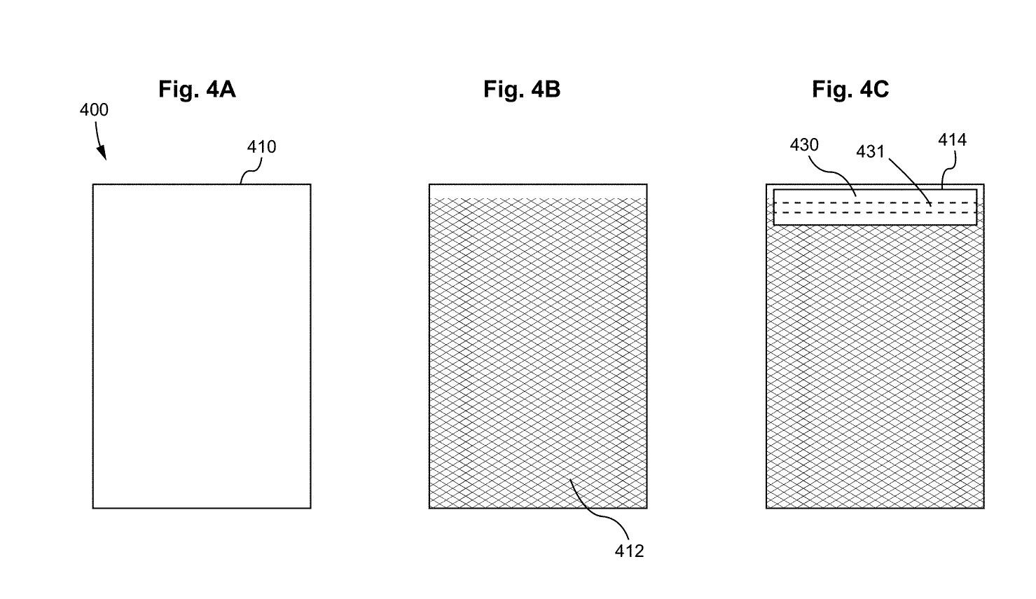

Referring now to FIGS. 4A-4C, in some embodiments, a container can include a liquid-impregnated surface. For example, a container 400 includes a native surface 410 that defines an internal region for containing a contact liquid. A texturing member 412 is disposed on the native surface 410 and a liquid delivery mechanism 414 is coupled to a portion of the native surface 410 and to a portion of the texturing member 412 such that an impregnating liquid (not shown) can be delivered to the texturing member 412 to create a liquid impregnated surface. The texturing member 412 can be substantially similar to the texturing member 12 described above, and therefore is not described in detail herein. The liquid delivery mechanism 414 can include a support member 430 configured to be coupled to the native surface 410 of the container 400, and a porous tubular member 431 configured to communicate impregnating liquid to the texturing member 412. The support member 430 can be configured to be removably coupled to the container 400. For example, in some embodiments, the support member 430 can be coupled to the native surface 410 with an adhesive. In some embodiments, the support member 430 can be coupled to the container 400 using mechanical fasteners (e.g., screws, bolts, clamps, etc.). In some embodiments, the support member 430 can define a channel (not shown) into which the porous tubular member 431 can be disposed. In some embodiments the porous tubular member 431 may have a cross sectional shape is round or not round (e.g. square), or may be porous only on a portion of the tube. In some embodiments the porosity of the tubular member 431 may be random or may be a series of holes. In some embodiments the tubular member 431 may built into the support mechanism as a channel with a porous side, or the support member may have a channel built-in, with a porous cover or membrane covering the channel. In some embodiments, the pore size of for the machined channel is small enough that capillary forces containing the liquid prevent the liquid from flowing out of the porous member, unless the liquid is pressurized above a threshold, breakthrough pressure. In some embodiments the channel 431 may be machined directly into the texturing member, or directly into the native surface 410.

In some embodiments, the liquid delivery mechanism can be fluidically coupled to a reservoir (not shown) containing a supply of the impregnating liquid. In some embodiments, the communication of a replenishing supply of impregnating liquid is aided by gravitational force due to an elevation difference between the reservoir and the porous tubular member 431. In some embodiments, the communication of a replenishing supply of impregnating liquid is aided by capillary force due to the dimensions and characteristics of the solid features disposed on the texturing member 412. In some embodiments, the communication of a replenishing supply of impregnating liquid is aided by a temperature differential due to a difference in temperature between the reservoir and the liquid impregnated surface. In some embodiments, the communication of a replenishing supply of impregnating liquid is aided by hydraulic pressure from a pumping device, forcing impregnating liquid to flow from the reservoir to the porous tubular member 431. In some embodiments, the liquid reservoir has a pressure greater than the ambient pressure, or greater than the pressure at of the atmosphere in contact with native surface or the liquid-impregnating or liquid-encapsulated surface or greater than the maximum hydrostatic pressure exhibited by the contact liquid, the greater pressure thereby forcing impregnating liquid to flow from the reservoir to the porous tubular member 431 In some embodiments gravitation force alone forces the impregnating liquid from the reservoir to porous tubular member 430. In some embodiments, at least one of a gravitational force, capillary force, temperature differential, hydraulic pressure, or any combination thereof aids the communication of a replenishing supply of impregnating liquid to the liquid-impregnated surface.

In some embodiments, the interstitial regions can be resupplied with the impregnating liquid by condensation of the impregnating liquid from a vapor phase in contact with the liquid-impregnated surface disposed on the texturing member 412. In such embodiments, the liquid-impregnated surface can be held at a temperature such that the saturation concentration at the temperature of the liquid-impregnated surface is less than the concentration of the impregnating liquid material in the vapor. In some embodiments, a non-solvent can be added to the impregnating liquid to reduce its solubility below the concentration at which the non-solvent was dissolved.

In some embodiments the textured member may have holes distributed randomly or uniformly across a portion or all of the surface such that the impregnating or encapsulating liquid can be replenished by conveying it from behind the texturing member through the pores to the liquid-impregnated or liquid encapsulated surface. This approach can reduce the time needed to replenish the surface.

Any impregnating liquid lost from the liquid-impregnating surface, for example, due to shearing or entrainment within the contact liquid, can be replaced by a replenishing supply of impregnating liquid from the reservoir, according to some embodiments. In some embodiments, the impregnating liquid can be communicated from the reservoir to the liquid-impregnated surface in a passive manner, for example, by capillary action, Venturi effect, pressure difference, gravity flow, or any combination thereof. In some embodiments, an active pumping mechanism can be used to communicate the impregnating liquid from the reservoir to the liquid-impregnated surface. Such pumping mechanisms can include, for example, a centrifugal pump, a gravity pump, a siphon pump, a peristaltic pump, a diaphragm pump, syringe pump, an air pump, a vacuum pump, a manual hand pump, any other suitable pumping mechanism, or any combination thereof. Furthermore, instrumentation, for example, flow valves, flow meters, controllers, PID controllers, pressure gauges, any other instrumentation, or any combination thereof, can be used to control the flow rate of the impregnating liquid to the liquid-impregnated surface. For example, the flow rate of the impregnating liquid can be adjusted to ensure that the solid features on the texturing member 412 are completely impregnated with the impregnating liquid. In some embodiments, the pressure can be controlled, for example, to provide a constant flow at a specific rate of the impregnating liquid to the liquid-impregnated surface.

In some embodiments, the impregnating liquid can also be supplied through nucleation, such as by condensation from a vapor phase, or by direct nucleation of impregnating liquid from a contact liquid solution that includes the impregnating liquid. In some embodiments, the flow of impregnating liquid can also be osmotically drive, or driven via a concentration gradient. In some embodiments, the wetting ridge of impregnating liquid in front of the contact liquid can replenish interstitial regions of plurality of features, as it passes over interstitial regions that are partially depleted of impregnating liquid.

In some embodiments, a liquid-impregnated surface can include an impregnating liquid can be a ferromagnetic liquid, i.e., a liquid that has magnetic properties (e.g., an impregnating liquid that includes ferrous or magnetic micro or nano particles). In such embodiments, the solid features can be magnetic or non-magnetic. A magnetic field can be used to stabilize the ferromagnetic impregnating liquid within and/or on the solid features. Furthermore, the magnetic field can be configured to maintain a replenishing supply of the ferromagnetic impregnating liquid within the interstitial regions defined by the solid features. For example, the magnetic field can magnetically pull an excess volume of the ferromagnetic impregnating liquid over the solid features by dragging the magnetic field over the liquid-impregnated surface. In some embodiments, the liquid-impregnated surface that includes the ferromagnetic impregnating liquid can be disposed on the inner surface of a side wall of a container. In such embodiments, the magnetic field can be used to resupply the ferromagnetic impregnating liquid to the inner surface of the container in a rapid manner. The container can include a detergent cup, a vessel, a tank, or any other container described herein. After the replenishing supply of the ferromagnetic liquid has been supplied to the liquid-impregnated surface, the magnetic field can be removed such that the replenishing supply of the ferromagnetic impregnating liquid is retained within the interstitial regions defined by the solid features included in the liquid-impregnated surface. Furthermore, in such embodiments a magnetic field may be used to separate from the Contact Liquid any of the ferromagnetic fluid that may be entrained or emulsified into the product.

In some embodiments, such as in a production tank or vessel used to manufacturing a liquid product, it can be desirable to reduce the amount of liquid that is depleted from the surface during mixing or reaction conditions. In some embodiments, in order to increase this robustness against depletion, the liquid can be configured and/or formulated to solidify during the mixing operation. For example, the lubricant can have a lower melting point that is lower than both the melting temperature of the product and the ambient temperature. The temperature of the wall of the tank can be lowered below the freezing temperature of lubricating (impregnating or encapsulating) liquid, to freeze the liquid in place until the product is ready to be evacuated. Shortly before evacuating the product, the temperature of the wall can then be increased back above the lubricating liquid's melting point, so that the frozen impregnating liquid liquefies again and the surface becomes slippery to allow the product to evacuate easily. Alternatively, the impregnating liquid can have a lower melting temperature that is lower than the melting temperature of the product, but higher than ambient temperature and when the tank is ready to be evacuated, the tank can be heated to melt the lubricating liquid, and the tank and the liquid reservoir can be heated when the liquid is replenished to the surface.

In some embodiments the lubricating liquid can be a shear thickening liquid, such that under high shear conditions such as mixing, the lubricating liquid viscosity will increase, and resist being depleted from the surface.

In some embodiments an external electric field, a heat source, and/or a magnetic field, can be applied to the coating to temporarily increase the coating's viscosity and increase its resistance to removal by shear or other external forces. Alternatively, an electric field, a heat source, and/or a magnetic field can be applied during evacuation to cause the coating to reduce in viscosity.

In some embodiments, the lubricous liquid can be dissolved or emulsified into a carrier liquid to help transport the lubricating liquid more quickly over the surface, and/or to protect the lubricating liquid from evaporation. Thus, a carrier fluid or fluid mixture can be selected such that the lubricious liquid is completely or partially miscible or emulsifiable therein. In some embodiments, the carrier liquid can be chosen that is partially or completely miscible with the product so that after that the carrier fluid dissolves into the product, the lubricating liquid, which is immiscible with the product, and is left behind on the surface.

### Separation of Entrained Impregnating Liquid That is Entrained by the Contact Liquid

Any of the impregnating liquid supply systems described herein, can also be configured to withdraw impregnating liquid, thereby separating the impregnating liquid from the contact liquid, prior to exiting the pipe. This separation device can be placed at the end of a pipe or end of a region of the pipe having the liquid impregnated surface. This can reduce the amount of liquid that is released with the contact liquid at the exit of the pipe. The mechanism by which the impregnating liquid is depleted from the surface can be passive (such as through capillarity) or active, such as pumping the liquid away from the surface (e.g., by maintaining a reservoir pressure that is less than the pressure within the pipe). To prevent the contact liquid from passing through the hole or through holes to the liquid reservoir, the holes can be dimensioned to be sufficiently small to increase the breakthrough pressure (i.e., the pressure differential required to overcome capillary pressure differences). Alternatively, the holes could be larger, provided that the plurality of solid features disposed over the holes (e.g., a mesh) have very small pores to increase the breakthrough pressure. It is also desirable that θ₁ₛ₍ₑ₎<θ_{c} for s denoting a smooth surface of the same material that the interior surface of the separation device is composed of and additionally desirable for θ₁ₛ₍ₑ₎<θ_{c} for s being the material comprising the plurality of features.

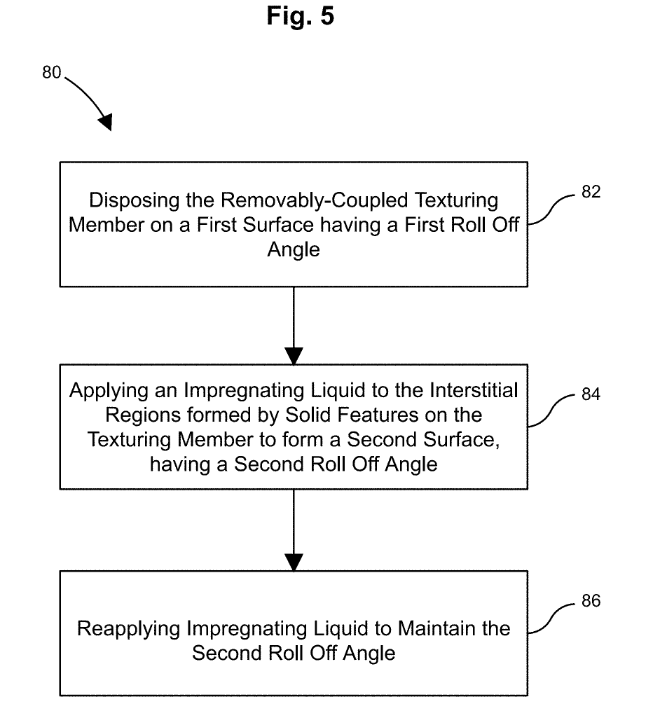

A liquid-impregnated surface (e.g., any liquid impregnated surfaces described herein) can be formed using various methods. FIG. 5 illustrates a flowchart of an exemplary method 80 for forming a liquid-impregnated surface. In some embodiments, a method 80 of forming a liquid-impregnated surface includes disposing a texturing member, 82, on a native surface. The texturing member is removably disposed on a native surface having a first roll off angle. An impregnating liquid is applied to the interstitial regions formed by the solid features on the texturing member, 84, such that the impregnating liquid fills the interstitial regions between the plurality of solid features on the texturing member and forms a second surface having a second roll off angle less than the first roll off angle. The impregnating liquid can be applied using spray coating, dip coating, spin coating, pouring, vapor deposition method or through any other method described herein. The method further includes reapplying the impregnating liquid to maintain the second roll off angle, 86 of the second surface less than the first roll off angle. This can, for example, maintain the super hydrophobicity or non-wettability of the liquid-impregnated surface. In some embodiments, the impregnating liquid can be reapplied from a liquid delivery mechanism which can be fluidically coupled with the interstitial regions of the liquid-impregnated surface. In some embodiments, the liquid delivery mechanism can be fluidically coupled with the interstitial regions by capillary action. In some embodiments, the liquid delivery mechanism can be fluidically coupled with the interstitial regions by a pressure differential (e.g., a pressure difference created by a pumping mechanism), or any combination thereof.

The embodiments of the removably coupled texturing member and liquid-impregnated surface apparatus, liquid-resupply mechanisms, and methods for producing, combining, and operating the same included in the present disclosure are examples included only for illustrative purposes and are not intended to limit the scope of the present disclosure.

As described herein, in some embodiments a texturing member is disposed on a substrate and an impregnating liquid is disposed on the texturing member to create a liquid impregnated surface. The texturing member can be replaced with a substantially smooth member (i.e., little or no texture) and the impregnating liquid can be replaced with an “encapsulating liquid”, thereby creating a liquid encapsulated surface. In addition, the texturing member can be used with an encapsulating liquid. In other words, the encapsulating liquid can be disposed on a texturing member in excess such that there is a mobile excess layer of liquid above the texture.

In some embodiments the textured can be engineered such that the textures changes shape and/or size (e.g., increase or decrease) in response to an increase or a decrease in an external field, such as an electric field, magnetic field, heat source, cooling source, or shear stress supplied by the contact fluid, such that that liquid does not completely fill the space between features, deeper within the textures and therefore more protected from depletion from external shear forces, gravity, or evaporation. Thus the change is size or shape can be triggered to reduced depletion whenever the extra resistance to depletion is desired, (e.g. during mixing in a mixing tank). The triggered increase in resistance to depletion can be configured to reduce the slipperiness of the surface, therefore, when slippery properties are preferred over resistance to liquid depletion (such as when a tank is being evacuated) the external field can be reversed to the “untriggered” state, so that that shape/size of the features returns or substantially returns to their original state, thereby restoring the slippery properties. Similarly, the any of the aforementioned external fields can be applied or changed to change a shape in the features to increase the capillary forces holding the liquid to increase resistance to depletion, and then reversed back again when more slipperiness is desired. In any of the cases above, the texture material can be chosen (engineered) such that it the texture achieves the desired response to the any of the external fields.

1. An apparatus having a liquid-encapsulated surface, comprising:
a substrate;
a member coupled to the substrate,
an encapsulating liquid disposed on a surface of the member, the surface of the member having a chemistry such that the encapsulating liquid preferentially wets the surface and maintains lubricity in the presence of a contacting phase, the encapsulating liquid being immiscible with the contacting phase, having a thickness of less than about 200 microns, and a receding contact angle of less 20 degrees in the presence of the contacting phase;
a liquid delivery mechanism including a porous tubular member configured to transfer a controlled volume of the encapsulating liquid to the member.

2. The apparatus of claim 1, wherein the member is configured to be removably coupled to the substrate.

3. The apparatus of claim 1, wherein the member includes an adhesive backing configured to be removably coupled to the substrate.

4. The apparatus of claim 1, wherein the liquid delivery mechanism includes a reservoir configured to contain a supply of encapsulating liquid, the reservoir fluidically coupled to the member such that a supply of encapsulating liquid can flow onto the member.

5. The apparatus of claim 1, wherein the liquid delivery mechanism includes a pumping mechanism configured to transfer encapsulating liquid from the reservoir to the member.

6. The apparatus of claim 1, wherein the surface of the member has little or no texture.

7. The apparatus of claim 1, wherein the surface of the member is substantially smooth.

8. An apparatus having a liquid-impregnated surface, comprising:
a substrate;
a texturing member coupled to the substrate, the texturing member having a plurality of solid features defining interstitial regions between the plurality of solid features;
an impregnating liquid disposed in the interstitial regions, the interstitial regions dimensioned and configured to remain impregnated by the impregnating liquid through capillarity; and
a liquid delivery mechanism including a porous tubular member configured to transfer a controlled volume of the impregnating liquid to the interstitial regions.

9. The apparatus of claim 8, wherein the texturing member is configured to be removably coupled to the substrate.

10. The apparatus of claim 8, wherein the texturing member includes an adhesive backing configured to be removably coupled to the substrate.

11. The apparatus of claim 8, wherein the liquid delivery mechanism includes a reservoir configured to contain a supply of impregnating liquid, the reservoir fluidically coupled to the interstitial regions such that a supply of impregnating liquid can flow into the interstitial regions by capillary action.

12. The apparatus of claim 11, wherein the reservoir containing the supply of impregnating liquid is at a higher pressure than the interstitial regions such that the supply of impregnating liquid is forced into the interstitial regions by the pressure differential.

13. The apparatus of claim 11, wherein the liquid delivery mechanism includes a pumping mechanism configured to transfer impregnating liquid from the reservoir to the interstitial regions.

14. An apparatus, comprising:
a container having an interior surface and defining an interior region configured to contain a contact liquid;
a texturing member disposed on the interior surface,
an impregnating liquid disposed on the texturing member; and
a liquid delivery mechanism including a porous tubular member configured to transfer a volume of the impregnating liquid to the texturing member.

15. The apparatus of claim 14, wherein the liquid delivery mechanism includes a support member coupled to the interior surface of the container, the liquid delivery mechanism defining a channel configured to receive the porous tubular member.

16. The apparatus of claim 15, wherein the support member is disposed about the circumference of the container.

17. The apparatus of claim 14, wherein the contact liquid includes at least one of a food, cosmetic, cement, asphalt, tar, ice cream, egg yolk, water, alcohol, mercury, gallium, refrigerant, toothpaste, paint, peanut butter, jelly, jam, mayonnaise, ketchup, mustard, condiment, laundry detergent, consumer product, gasoline, petroleum product, oil, biological fluid, blood, and plasma.

18. An apparatus having a liquid-encapsulated surface, comprising:
a substrate;
a member coupled to the substrate,
an encapsulating liquid disposed on a surface of the member, the surface of the member having a chemistry such that the encapsulating liquid preferentially wets the surface and maintains lubricity in the presence of a contacting phase, the encapsulating liquid being immiscible with the contacting phase, having a thickness of less than about 200 microns, and a receding contact angle of less 20 degrees in the presence of the contacting phase;
a liquid delivery mechanism including a reservoir configured to contain a supply of the encapsulating liquid, the reservoir fluidically coupled to the member such that the supply of the encapsulating liquid can flow onto the member.

19. The apparatus of claim 18, wherein the member is configured to be removably coupled to the substrate.

20. The apparatus of claim 18, wherein the member includes an adhesive backing configured to be removably coupled to the substrate.

21. The apparatus of claim 18, wherein the liquid delivery mechanism includes a porous tubular member configured to transfer a controlled volume of the encapsulating liquid to the member.

22. The apparatus of claim 18, wherein the liquid delivery mechanism includes a pumping mechanism configured to transfer encapsulating liquid from the reservoir to the member.

23. The apparatus of claim 18, wherein the surface of the member has little or no texture.

24. The apparatus of claim 18, wherein the surface of the member is substantially smooth.

25. An apparatus having a liquid-impregnated surface, comprising:
a substrate;
a texturing member coupled to the substrate, the texturing member having a plurality of solid features defining interstitial regions between the plurality of solid features;
an impregnating liquid disposed in the interstitial regions, the interstitial regions dimensioned and configured to remain impregnated by the impregnating liquid through capillarity; and
a liquid delivery mechanism including a reservoir configured to contain a supply of impregnating liquid, the reservoir fluidically coupled to the interstitial regions such that a supply of impregnating liquid can flow into the interstitial regions by capillary action.

26. The apparatus of claim 25, wherein the texturing member is configured to be removably coupled to the substrate.

27. The apparatus of claim 25, wherein the texturing member includes an adhesive backing configured to be removably coupled to the substrate.

28. The apparatus of claim 25, wherein the liquid delivery mechanism includes a porous tubular member configured to transfer a controlled volume of the impregnating liquid to the interstitial regions.

29. An apparatus having a liquid-impregnated surface, comprising:
a substrate;
a texturing member coupled to the substrate, the texturing member having a plurality of solid features defining interstitial regions between the plurality of solid features;
an impregnating liquid disposed in the interstitial regions, the interstitial regions dimensioned and configured to remain impregnated by the impregnating liquid through capillarity; and
a liquid delivery mechanism including a reservoir configured to contain a supply of impregnating liquid at a higher pressure than the interstitial regions such that the supply of impregnating liquid is forced into the interstitial regions by the pressure differential.

30. The apparatus of claim 29, wherein the texturing member is configured to be removably coupled to the substrate.

31. The apparatus of claim 29, wherein the texturing member includes an adhesive backing configured to be removably coupled to the substrate.

32. The apparatus of claim 29, wherein the liquid delivery mechanism includes a porous tubular member configured to transfer a controlled volume of the impregnating liquid to the interstitial regions.

33. The apparatus of claim 29, wherein the liquid delivery mechanism includes a pumping mechanism configured to transfer impregnating liquid from the reservoir to the interstitial regions.

34. An apparatus having a liquid-impregnated surface, comprising:
a substrate;
a texturing member coupled to the substrate, the texturing member having a plurality of solid features defining interstitial regions between the plurality of solid features;
an impregnating liquid disposed in the interstitial regions, the interstitial regions dimensioned and configured to remain impregnated by the impregnating liquid through capillarity; and
a liquid delivery mechanism including a reservoir configured to contain a supply of impregnating liquid, the liquid delivery mechanism includes a pumping mechanism configured to transfer impregnating liquid from the reservoir to the interstitial regions.

35. The apparatus of claim 34, wherein the texturing member is configured to be removably coupled to the substrate.

36. The apparatus of claim 34, wherein the texturing member includes an adhesive backing configured to be removably coupled to the substrate.

37. The apparatus of claim 34, wherein the liquid delivery mechanism includes a porous tubular member configured to transfer a controlled volume of the impregnating liquid to the interstitial regions.

38. The apparatus of claim 34, wherein the reservoir containing the supply of impregnating liquid is at a higher pressure than the interstitial regions such that the supply of impregnating liquid is forced into the interstitial regions by the pressure differential.
